(19) United States
(12) Patent Application Publication
(10) Pub. No.: US 2018/0120081 A1
(43) Pub. Date: May 3, 2018

(54) MEASURING DEVICES WITH ATTACHABLE ACCESSORIES AND METHODS OF USING THE SAME

(71) Applicant: InstruMMents, Inc., Montreal, CA (US)

(72) Inventors: Mladen BARBARIC, Westmount (CA); Minkyu CHOI, St-Laurent (CA); Bong KIM, Montreal (CA); Sungmoon KIM, St-Laurent (CA); Kisae KIM, Westmount (CA)

(73) Assignee: InstruMMents, Inc., Montreal (CA)

(21) Appl. No.: 15/796,387

(22) Filed: Oct. 27, 2017

Related U.S. Application Data
(60) Provisional application No. 62/413,581, filed on Oct. 27, 2016.
(60) Provisional application No. 62/430,683, filed on Dec. 6, 2016.

(51) Int. Cl. G01B 7/04; B43K 31/00

(52) U.S. Cl. CPC G01B 7/046; B43K 31/00

(57) ABSTRACT

An apparatus includes a first portion having a first housing, an electronics assembly disposed within the first housing, and a wheel assembly rotatably coupled to a first end portion of the first housing. The wheel assembly includes a wheel configured to rotate in response to being moved along a surface, and a magnetic member operably coupled to the wheel and configured to change a magnetic field in response to the rotation of the wheel. The electronics assembly is configured to determine a measurement associated with the surface based on the change in the magnetic field. The second portion includes a second housing having a first end portion configured to removably couple to a second end portion of the first housing, and a second end portion configured to at least partially house at least one of a writing instrument or an output instrument.

### CROSS-REFERENCE TO RELATED APPLICATIONS

This application claims priority to and the benefit of U.S. Provisional Patent Application Ser. No. 62/413,581 entitled, “Measuring Devices with Attachable Accessories and Methods of Using the Same,” filed Oct. 27, 2016, the disclosure of which is incorporated herein by reference in its entirety.

This application also claims priority to and the benefit of U.S. Provisional Patent Application Ser. No. 62/430,683 entitled, “Measuring Devices with Attachable Accessories and Methods of Using the Same,” filed Dec. 6, 2016, the disclosure of which is incorporated herein by reference in its entirety.

### BACKGROUND

The embodiments described herein relate to devices for taking measurements and/or dimensions and more particularly, to measuring and/or dimensioning devices with attachable accessories such as a writing utensil, stylus, and/or the like.

Many devices and/or methods for taking measurements and/or for dimensioning exist. In some instances, such measuring and/or dimensioning devices (referred to herein as “measuring device”) are tailored and/or otherwise designed for an intended use and may, in other instances, present challenges for taking accurate measurements. For example, tape measurers are known and commonly used. In general, tape measurers include a series of indicators such as tick marks that typically provide a user with an indication of a linear distance. Known tape measurers, however, may not be suitable and/or may otherwise provide inaccurate measurements in some instances such as, for example, when measuring along a curved or otherwise non-linear path.

As another example, measuring wheels (e.g., a surveyor's wheel or the like) have been used to measure distances along a surface. Some known measuring wheels include and/or employ optical and/or mechanical tracking to determine a number of rotations and/or a fraction thereof of the wheel, which in turn, can be used to provide a measurement associated with a distance traversed along a surface (e.g., a linear or curvilinear direction). More particularly, an optical sensor and/or mechanical gauge can determine a number or rotations of a wheel moving along a surface by detecting one or more indicators (e.g., tick marks, holes, protrusions, and/or any other suitable indicia). In some instances, by knowing the wheel's diameter and the number of rotations, the distance traversed along the surface can be determined as the product of the diameter, the number of rotations, and the constant, pi (Distance=diameter*rotation*π). Some known measuring wheels, however, may provide inaccurate measurements if, for example, the wheel is rotated in an opposite direction and/or loses adequate contact or traction with the surface.

Moreover, the use of some known measuring devices such as those described above may be inconvenient by requiring a user to employ a separate writing utensil (e.g., a pencil, a pen, a stylus, etc.) to, for example, mark location of measurement on a surface. Accordingly, a need exists for improved measuring and/or dimensioning devices with attachable accessories such as a writing utensil, stylus, and/or the like. Moreover, a need exists for devices and/or methods for digitizing and/or otherwise presenting such measurements for and/or to a user.

### SUMMARY

Devices and methods for taking measurements and/or dimensions are described herein. In some embodiments, an apparatus includes a first portion and a second portion. The first portion includes a first housing, an electronics assembly disposed within the first housing, and a wheel assembly rotatably coupled to a first end portion of the first housing. The wheel assembly includes a wheel configured to rotate in response to being moved along a surface and a magnetic member operably coupled to the wheel and configured to change a magnetic field in response to the rotation of the wheel. The electronics assembly configured to determine a measurement associated with the surface based on the change in the magnetic field. The second portion includes a second housing. A first end portion of the second housing is configured to removably couple to a second end portion of the first housing opposite the first end portion of the first housing. A second end portion of the second housing configured to at least partially house at least one of a writing instrument or an output instrument.

### BRIEF DESCRIPTION OF THE DRAWINGS

FIG. 1 is a schematic illustration of a measuring device according to an embodiment.

FIGS. 2 and 3 are a front view and a perspective view, respectively, of a measuring device according to an embodiment.

FIG. 4 is a partially exploded perspective view of the measuring device of FIG. 2.

FIG. 5 is a front view of a first portion of the measuring device of FIG. 2.

FIG. 6 is a partially exploded perspective view of the first portion of the measuring device shown in FIG. 5.

FIG. 7 is a partially exploded perspective view of an electronics assembly and a wheel assembly included in the first portion shown in FIG. 5.

FIG. 8 is a front view of a housing included in the electronics assembly of FIG. 8.

FIG. 9 is a front view of the first portion of the measuring device of FIG. 5, shown with a portion of a housing cut-away.

FIG. 10 is a perspective view of a portion of the electronics assembly of FIG. 8 illustrating at least a printed circuit board.

FIG. 11 is an exploded view of a battery assembly included in the first portion of the measuring device shown in FIG. 5.

FIG. 12 is a front view of the battery assembly of FIG. 11.

FIG. 13 is a cross-sectional view of the battery assembly taken along the line 13-13 in FIG. 12.

FIG. 14 is an exploded perspective view of the wheel assembly shown in FIG. 8.

FIG. 15 is a top view of the first portion of the measuring device shown in FIG. 5.

FIG. 16 is a top view of the first portion of the measuring device of FIG. 5, shown without a contact wheel of the wheel assembly.

FIG. 17 is a cross-sectional view of the first portion of the measuring device taken along the line 17-17 in FIG. 5.

FIG. 18 is a front view of a second portion of the measuring device shown in FIG. 2.

FIG. 19 is an exploded view of the second portion of the measuring device shown in FIG. 18.

FIG. 20 is a cross-sectional view of the second portion of the measuring device taken along the line 20-20 in FIG. 18.

FIG. 21 is an enlarged cross-section view of the second portion of the measuring device identified in FIG. 20 by region X.

FIG. 22 illustrates a three-dimensional rendering of a chair according to an embodiment.

FIG. 23 illustrates a three-dimensional point trail associated with a surface of the chair of FIG. 22 based on data calculated, determined, and/or produced by a measuring device according to an embodiment.

FIG. 24 is a flowchart illustrating a method of using a measuring device according to an embodiment.

### DETAILED DESCRIPTION

In some embodiments, an apparatus includes a first portion and a second portion. The first portion includes a first housing, an electronics assembly disposed within the first housing, and a wheel assembly rotatably coupled to a first end portion of the first housing. The wheel assembly includes a wheel configured to rotate in response to being moved along a surface and a magnetic member operably coupled to the wheel and configured to change a magnetic field in response to the rotation of the wheel. The electronics assembly configured to determine a measurement associated with the surface based on the change in the magnetic field. The second portion includes a second housing. A first end portion of the second housing is configured to removably couple to a second end portion of the first housing opposite the first end portion of the first housing. A second end portion of the second housing configured to at least partially house at least one of a writing instrument or an output instrument.

In some embodiments, an apparatus includes a first housing, a second housing, a wheel assembly, an electronics assembly, and a writing instrument. The first housing has a first end portion and a second end portion and defines a cavity. The wheel assembly is coupled to the first end portion of the first housing and includes a wheel configured to rotate relative to the housing in response to being moved along a surface. The electronics assembly is disposed within the cavity of the first housing. The electronics assembly including an optical output device configured to project an output on the surface to provide a guide to a user as the user moves the wheel along a path on the surface. The electronics assembly is configured to determine a measurement associated with the path on the surface based on data associated with the rotation of the wheel relative to the housing. The second housing has a first end portion and a second end portion. The first end portion of the second housing is configured to removably couple to the second end portion of the first housing. The writing instrument is coupled to the second end portion of the second housing and is at least partially disposed therein.

In some embodiments, a method of using a measuring device having a wheel assembly included in a first portion of the measuring device, an electronics assembly disposed within the first portion of the measuring device, and a writing instrument included in a second portion of the measuring device includes placing a wheel of the wheel assembly in contact with a surface. The wheel is moved along at least a portion of the surface. The movement of the wheel results in a rotation of a portion of the wheel assembly. At least one dimension associated with at least the portion of the surface is determined. Information associated with the at least one dimension can then be written on a medium using the writing instrument.

In some embodiments, a device includes a first portion and a second portion. The first portion includes a housing, an electronics assembly disposed within the housing, and a wheel assembly rotatably coupled to a first end of the housing. The wheel assembly includes a contact wheel configured to rotate in response to being moved along a surface and a magnetic member configured to rotate in response to the rotation of the contact wheel. The electronics assembly is configured to determine a measurement associated with the surface based on at least one characteristic associated with the contact wheel and a rotation of the magnetic member. The second portion includes a housing having a first end and a second end. The first end of the housing included in the second portion is configured to removably couple to the second end of the housing included in the first portion. The housing of the second portion is configured to at least partially house at least one of a writing instrument or an input instrument.

As used in this specification, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the value stated. For example, about 0.5 would include 0.45 and 0.55, about 10 would include 9 to 11, about 1000 would include 900 to 1100. Similarly, the term “substantially” when used in connection with geometric relationships (e.g., cylindrical, rectangular, linear, perpendicular, parallel, etc.) is intended to convey that the structure(s) so defined is/are nominally the desired geometric relationship. As one example, a portion of a body, housing, or wall that is described as being “substantially cylindrical” is intended to convey that, although a cylindrical shape of the portion is desirable, some variance can occur in a “substantially cylindrical” portion. Such variance can result from manufacturing tolerances or other practical considerations. Thus, as described above with reference to the terms “about” and “approximately” a geometric construction modified by the term “substantially” includes such geometric properties within a tolerance of plus or minus 10% of the stated geometric construction. In other instances, the terms “about,” “approximately,” and/or “substantially” can be associated with a variance from the stated value or geometric relationship that is less than 10% and/or that otherwise accords with industry standards, practices, expectations, and/or the like.

As used herein, the term “parallel” generally describes a relationship between two geometric constructions (e.g., two lines, two planes, two axes, a combination thereof, and/or the like) in which the two geometric constructions are substantially non-intersecting as they extend substantially to infinity. For example, as used herein, an axis is said to be parallel to another axis when the axes do not intersect as they extend to infinity. Similarly, when a planar surface (i.e., a two-dimensional surface) is said to be parallel to a line, every point along the line is spaced apart from the nearest portion of the surface by a substantially equal distance. Two geometric constructions are described herein as being “parallel” or “substantially parallel” to each other when they are nominally parallel to each other, such as for example, when they are parallel to each other within a tolerance. Such tolerances can include, for example, manufacturing tolerances, measurement tolerances or the like.

As used herein, the term “set” can refer to multiple features or a singular feature with multiple parts. For example, when referring to set of walls, the set of walls can be considered as one wall with multiple portions, or the set of walls can be considered as multiple, distinct walls. Thus, a monolithically constructed item can include a set of walls. Such a set of walls may include multiple portions that are either continuous or discontinuous from each other. For example, a monolithically constructed item can include a set of detents and/or protrusions that can be said to form a set of walls. A set of walls can also be fabricated from multiple items that are produced separately and are later joined together (e.g., via a weld, an adhesive, or any suitable method).

As used herein, the term “end” can refer to a point, a surface, and/or a portion of an object that is at, near, or that otherwise forms an extremity. For example, in some instances, the term “end” can refer to a point or surface that forms an extremity or outermost structure of the feature or object so described. In other instances, the term “end” can refer to an end portion or end region of a feature or object so described. In such instances, the “end” can include, for example, a point or surface that forms an extremity or outermost structure of the feature or object, as well as at least a portion or region of feature or object adjacent thereto. Accordingly, as used herein, the meaning of the term “end” is made clear by the context in which it is described and the scope thereof is not intended to be limited unless explicitly described.

The devices and/or methods described herein can be used to accurately and conveniently measure and/or dimension drawings, objects, surfaces, spaces, and/or the like. By way of example, a user can manipulate any of the devices described herein to rotate a portion of a wheel assembly or the like along a surface. One or more characteristics associated with the portion of the wheel assembly and/or the rotation thereof, in turn, can be used to calculate and/or determine one or more dimensions associated with the surface along which the portion of the wheel assembly is rotated. In addition, any of the devices described herein can include and/or can be selectively coupled to any suitable device, accessory, instrument, utensil, and/or the like. For example, any of the devices described herein can include and/or can be coupled to a writing utensil (e.g., a pencil, pen, etc.), stylus, and/or the like.

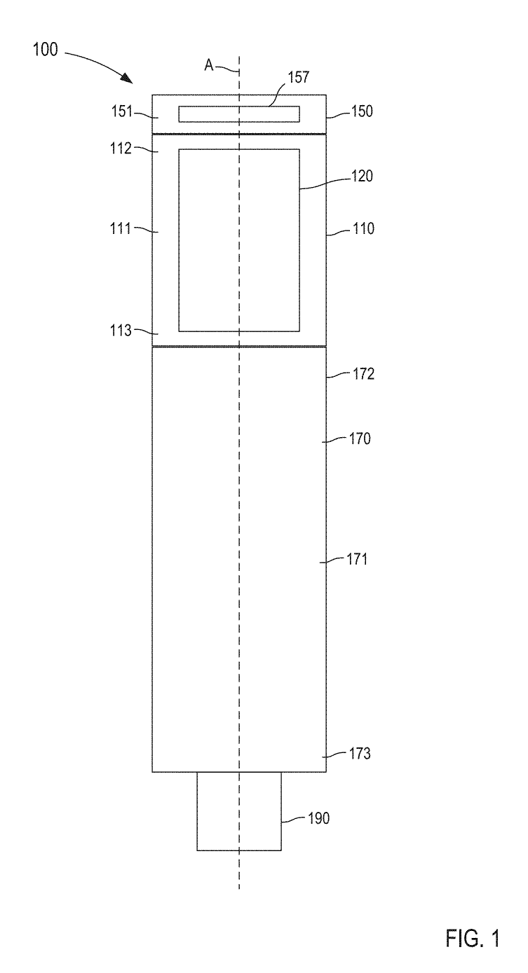

FIG. 1 is a schematic illustration of a measuring and/or dimensioning device 100 according to an embodiment. The measuring and/or dimensioning device 100 (referred to herein as “measuring device” or “device”) can be any suitable shape, size, and/or configuration. In some embodiments, for example, the size, shape, and/or configuration of the measuring device 100 can be designed to increase the ergonomics associated with use of the device 100. In some embodiments, the device 100 can have a size and/or shape that is suitable for single-handed operation. More particularly, in some embodiment, the device 100 can have a size and/or shape that is similar to some known writing utensils (e.g., pens, pencils, markers, etc.), styluses, and/or the like.

As shown in FIG. 1, the measuring device 100 includes a first portion 110 and a second portion 170. In some embodiments, the first portion 110 and the second portion 170 can be removably coupled to collectively form the device 100 (e.g., via a threaded coupling, a snap fit, a friction fit, an interference fit, and/or any suitable releasable coupling mechanism. In some embodiments, such an arrangement can allow the first portion 110 of the device 100 to be used interchangeably with a second portion 170 having various configurations (or vice versa), as described in further detail herein.

The first portion 110 of the device 100 includes a housing 111, an electronics assembly 120, and a wheel assembly 150. The housing 111 can be any suitable shape, size, and/or configuration. For example, in some embodiments, the housing 111 can be a substantially cylindrical or annular tube configured to contain and/or house at least a portion of the electronics assembly 120 and/or wheel assembly 150. In other words, the housing 111 can define an inner volume or cavity in which at least a portion of the electronics assembly 120 and/or at least a portion of the wheel assembly 150 can be disposed. As described above, the housing 111 can have a size and/or shape that is suitable for single-handed operation and/or the like. As shown, the housing 111 includes a first end 112 and a second end 113 (e.g., a first end portion or region and a second end portion or region). The first end 112 of the housing 111 is coupled to the wheel assembly 150 such that a portion of the wheel assembly 150 can rotate relative thereto. The second end 113 of the housing 111 is configured to removably couple to the second portion 170 of the device 100, as described in further detail herein.

The electronics assembly 120 can be any suitable configuration. Although not shown in FIG. 1, the electronics assembly 120 can include any suitable computing device and/or electric/electronic component. For example, in some embodiment, the electronics assembly 120 can include a compute device having at least a processor and a memory. The processor can be, for example, a general-purpose processor (GPP), a central processing unit (CPU), an accelerated processing unit (APU), and/or the like. The memory can be, for example, a random access memory (RAM), a memory buffer, a hard drive, a solid-state drive (SSD), a read-only memory (ROM), an erasable programmable read-only memory (EPROM), a flash memory, and/or the like. In some embodiments, the processor and/or memory can be included in an application specific integrated circuit (ASIC) and/or electronically connected to any suitable printed circuit board (PCB). In some embodiments, the memory stores instructions to cause the processor to execute modules, code, processes, and/or functions associated with detecting a rotation of a portion of the wheel assembly 150 and/or determining a measurement and/or dimension associated with the rotation of the portion of the wheel assembly 150, as described in further detail herein. Although not shown in FIG. 1, the electronics assembly 120 can include any suitable electrical and/or electronic component such as, for example, a power supply, an optical output device, a sensor(s), a communication interface, a global positioning system (GPS), a compass, a gyroscope, a display, and/or the like, as described in further detail herein with reference to specific embodiments.

The wheel assembly 150 can be any suitable shape, size, and/or configuration. As described above, the wheel assembly 150 is coupled to the first end 112 (e.g., a first end portion) of the housing 111 such that a portion of the wheel assembly 150 can rotate relative thereto. For example, although not shown in FIG. 1, the wheel assembly 150 can include any suitable mechanism and/or set of components configured to couple the wheel assembly 150 to the first end 112 of the housing 111 while allowing at least a portion of the wheel assembly 150 to rotate relative to about an axis A (illustrated in FIG. 1 as a dashed line). For example, in the embodiment shown in FIG. 1, the wheel assembly 150 includes a contact wheel 151 configured to be placed in contact with a surface. The contact wheel 151, in turn, can be rotated along the surface and about the axis A as the device 100 (or at least the first portion 110) is moved relative to the surface.

As shown in FIG. 1, the wheel assembly 150 includes a magnetic member 157 that is configured to rotate in response to the rotation of the contact wheel 151. For example, in some embodiments, the magnetic member 157 can be rotated via one or more gears, chains, linkages, and/or the like. Thus, rotation of the contact wheel 151 in response to being moved along the surface results in a rotation of the magnetic member 157, which in turn, results in a rotation of and/or change in a magnetic field associated with the magnetic member 157. As described above, the electronics assembly 120 can include one or more magnetic sensors that can be configured to detect the rotation and/or change in the magnetic field associated with the magnetic member 157. In this manner, the electronics assembly 120 can determine an amount of rotation of the magnetic member 157 (e.g., a number of rotations or fractions thereof), which in turn, can be used to determine an amount of rotation of the contact wheel 151. Accordingly, with a diameter of the contact wheel 151 known, the electronics assembly 120 can determine and/or calculate a measurement associated with a path on the surface along which the contact wheel 151 is moved (e.g., rotated). That is to say, the electronics assembly 120 can determine and/or calculate a distance associated with the path on the surface along which the contact wheel 151 moves, as described in further detail herein with reference to specific embodiments.

Although not shown in FIG. 1, the electronics assembly 120 can include any suitable communication interface or the like (e.g., a network interface card) configured to send and/or receive data from one or more external electronic devices. For example, in some instances, after determining and/or calculating one or more measurements and/or dimensions, the electronics assembly 120 can send, via the communication interface, a signal to an external electronic device (e.g., a personal computer, laptop, mobile device, smartphone, wearable electronic device, etc.) that is indicative of an instruction to graphically represent, for example, data associated with the one or more measurements and/or dimensions on a display of the external electronic device.

In some embodiments, the use of the magnetic member 157 and magnetic sensor can allow for an accurate and/or precise measuring or dimensioning. For example, in some embodiments, the electronics assembly 120 (e.g., a processor or the like) can determine a measurement within about 1.0 millimeter (mm), about 0.9 mm, about 0.8 mm, about 0.7 mm, about 0.6 mm, about 0.5 mm, about 0.4 mm, about 0.3 mm, about 0.2 mm, about 0.1 mm, or less. Moreover, unlike some known measuring wheels using, for example, optical tracking or the like, the use of the magnetic member 157 and magnetic sensor can allow for bi-directional operation in which rotation of the contact wheel 151 in a first direction results in an increase in a value of a dimension or measurement and rotation of the contact wheel 151 in a second direction, opposite the first direction, results in a decrease in the value of the dimension or measurement. That is to say, in some instances, moving the contact wheel 151 along a surface in a first direction results in a positive or increasing measurement and moving the contact wheel 151 along the surface in a second direction, opposite the first direction, results in a negative or decreasing measurement. Thus, for example, if a user moves the contact wheel 151 beyond a desired point along a surface (thereby resulting in a measurement that is greater than the dimension of what is being measured), the user can move the contact wheel 151 in a substantially opposite direction (i.e., a reverse direction) to the desired point along the surface, which in turn, reduces the value of the measurement such that the measurement accurately reflects the dimension of what is being measured.

The second portion 170 of the device 100 can be any suitable shape, size, and/or configuration. In some embodiments, for example, the second portion 170 of the device 100 can have a size and/or shape that is substantially similar to at least a portion of some known writing utensils (e.g., pens, pencils, etc.). In the embodiment shown in FIG. 1, the second portion 170 of the device 100 includes a housing 171 having a first end 172 (e.g., a first end portion) and a second end 173 (e.g., a second end portion). As described above with reference to the first portion 110 of the device 100, the second portion 170 of the device 100 can have a size and/or shape that is suitable for single-handed operation and/or the like. The first end 172 of the housing 171 included in the second portion 170 is configured to removably couple to the second end 113 of the housing 111 included in the first portion 110. For example, in some embodiments, the first end 172 of the housing 171 and the second end 113 of the housing 111 can collectively form a threaded coupling, a snap fit, a friction fit, an interference fit, and/or any suitable releasable coupling therebetween. Although not shown in FIG. 1, in some embodiments, the second end 173 of the housing 171 can include an outer surface having any suitable surface finish such as, for example, a knurled finish, or the like. In some embodiments, such a surface finish can increase the ergonomics of the second portion 170.

In the embodiment shown in FIG. 1, the second portion 170 of the device 100 includes and/or is configured to couple to a writing instrument 190 and/or other suitable output. For example, in some embodiments, the writing instrument 190 can be graphite or graphite mixed with a clay binder or the like (i.e., pencil lead—“lead,” when used in this context is not to be confused with the element “lead” (Pb)). The writing instrument 190 is at least partially disposed within the housing 171 of the second portion 170. Although not shown in FIG. 1, the second portion 170 can include a holder or the like disposed within the housing 171 of the second portion 170 and configured to selectively hold or clamp the writing instrument 190, thereby selectively maintaining the writing instrument 190 in a fixed position relative to the housing 171. In this manner, a user can manipulate the second portion 170 (whether coupled to the first portion 110 or not) to use the writing instrument 190 to write and/or otherwise produce markings on a surface. In other words, the user can use the second portion 170 as a writing utensil such as a pencil.

Although the writing instrument 190 is described above as being, for example, pencil lead, in other embodiments, the writing instrument 190 can be any suitable configuration. For example, in some embodiments, the second portion 170 can include a writing instrument 190 configured as, for example, a ballpoint pen or the like. In other embodiments, the writing instrument 190 can be configured as a marker, colored pencil, grease pencil, crayon, chalk, etc. In still other embodiment, the writing instrument 190 can be configured as a stylus configured to be placed in contact with a touch-sensitive display of a computing device or the like. As such, the user move the stylus (e.g., writing instrument 190) along the touch-sensitive display, which in turn, can result in writing being graphically represented on the display and/or can otherwise result in user-inputs into the computing device. In other words, the writing instrument 190, when configured as a stylus, can be substantially similar in at least function to known styluses.

While the second portion 170 is described above as including a writing instrument 190, in other embodiments, the second portion 170 can have any suitable configuration and/or arrangement. For example, in some embodiments, the second portion 170 can be a clip or the like configured to removably engage an article of clothing or the like worn by the user. In other embodiments, the second portion 170 can be coupled to and/or can include, for example, a hook, loop, carabiner, magnet, leash, clasp, keychain, knife, probe, screwdriver, bottle opener, corkscrew, laser pointer, laser-measuring device, can opener, and/or any other suitable attachment or device.

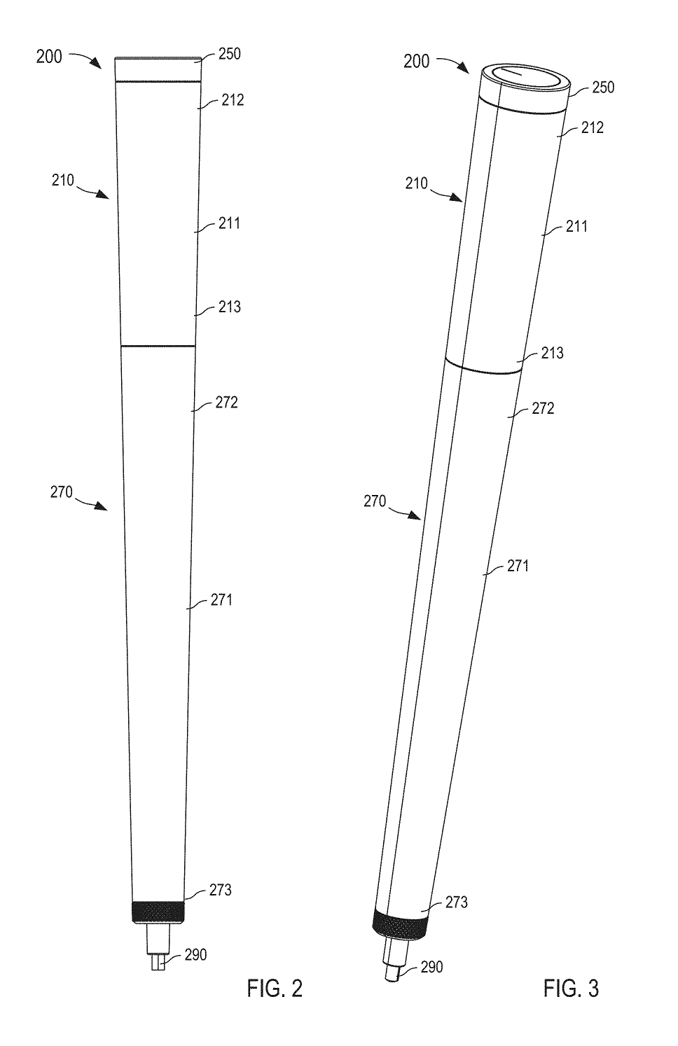

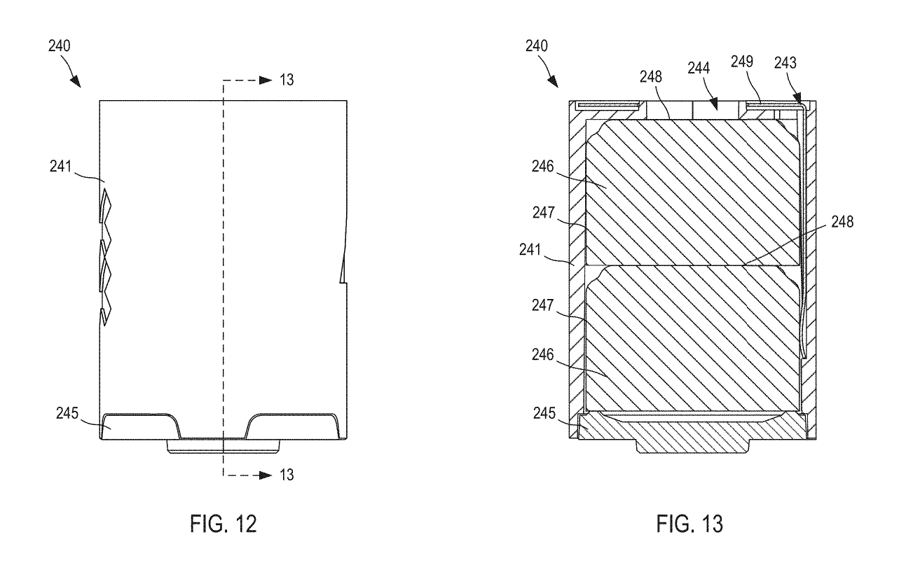

FIGS. 2-21 illustrate a measuring and/or dimensioning device 200 according to an embodiment. The measuring and/or dimensioning device 200 (referred to herein as “measuring device” or “device”) can be any suitable shape, size, and/or configuration. In some embodiments, for example, the size, shape, and/or configuration of the measuring device 200 can be designed to increase the ergonomics associated with use of the device 200. As shown in FIGS. 2 and 3, for example, the device 200 can have a size and/or shape that is suitable for single-handed operation and, more particularly, that is substantially similar to some known writing utensils (e.g., pens, pencils, markers, etc.), styluses, and/or the like.

As shown in FIGS. 2-4, the measuring device 200 includes a first portion 210 and a second portion 270. In some embodiments, the first portion 210 and the second portion 270 can be removably coupled to collectively form the device 200. For example, the first portion 210 and the second portion 270 can collectively form a threaded coupling. In some embodiments, such an arrangement can allow the first portion 210 of the device 200 to be used interchangeably with a second portion 270 having various configurations (or vice versa). For example, as described in further detail herein, the first portion 210 can be used to take measurements and/or dimensions of any suitable surface or the like and can be at least temporarily coupled to the second portion 270 configured for use as a pencil, pen, stylus, and/or the like.

The first portion 210 of the device 200 includes a housing 211, an electronics assembly 220, and a wheel assembly 250. In general, the first portion 210 of the device 200 can be used to measure and/or dimension any suitable surface, object, line, drawing, and/or the like, as described above with reference to the first portion 110 of the device 100 shown in FIG. 1. For example, the housing 211 of the first portion 210 can house and/or contain at least a portion of the electronics assembly 220 and/or the wheel assembly 250. The wheel assembly 250 includes a portion that can be moved (e.g., rolled) along a path on a surface and the electronics assembly 220 can detect and/or determine an amount of rotation of at least a portion of the wheel assembly 250. Furthermore, with a size and/or diameter of the portion of the wheel assembly 250 known, the electronics assembly 250 can determine and/or calculate a measurement and/or dimension associated with the movement of the portion of the wheel assembly 250 along the path on the surface, as described in further detail herein.

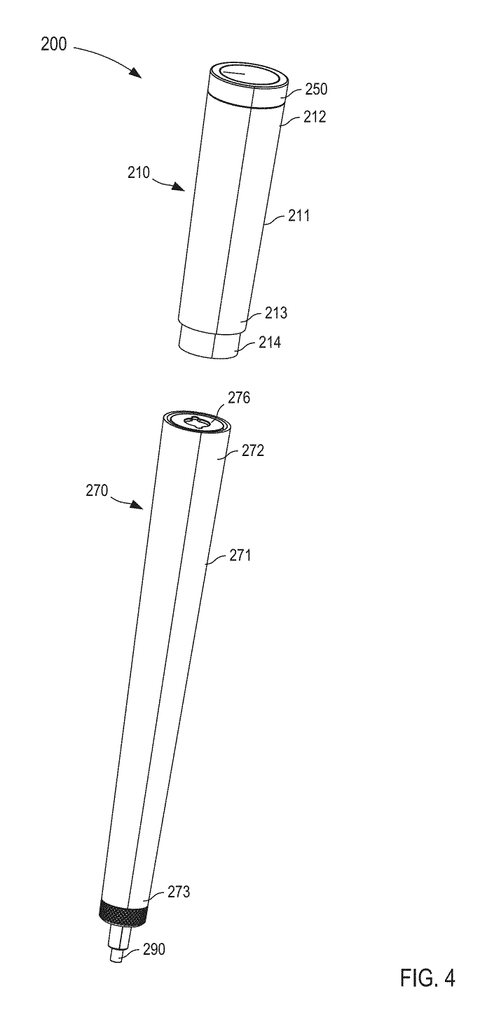

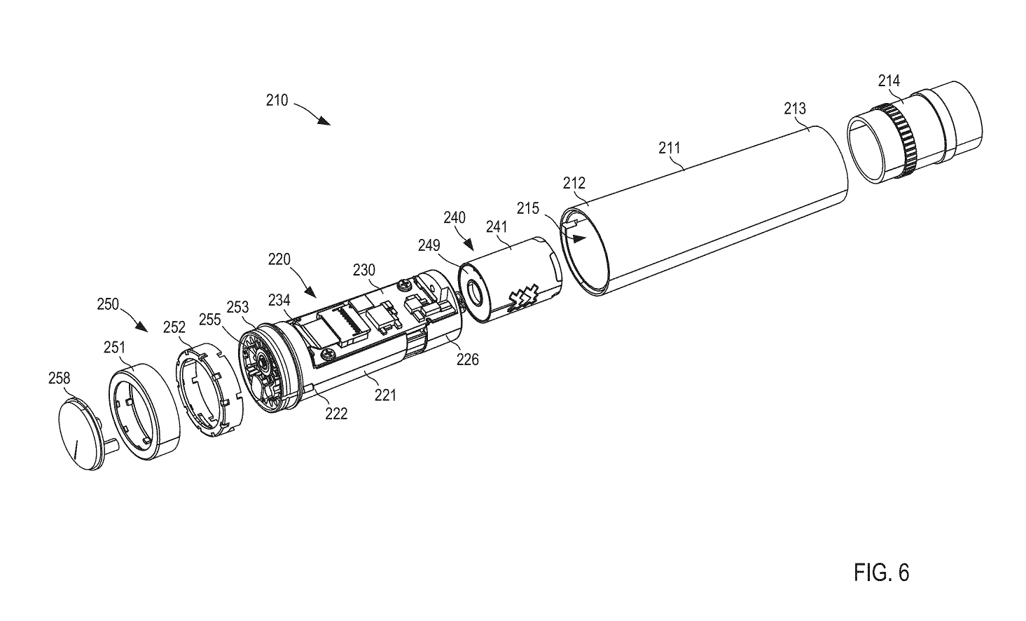

Expanding further, the housing 211 of the first portion 210 can be any suitable shape, size, and/or configuration. In the embodiment shown in FIGS. 4-7, for example, the housing 211 of the first portion 210 includes and/or is formed of a set of substantially annular walls and has a first end 212 (e.g., first end portion) and a second end 213 (e.g., a second end portion). In some embodiments, the housing 211 can be substantially cylindrical or rounded with a diameter that is tapered from a first diameter at or near the first end 212 (e.g., a larger diameter) to a second diameter at or near the second end 213 (e.g., a smaller diameter). As shown in FIG. 6, the housing 211 defines an inner volume and includes an inner wall 217. The inner wall 217 substantially traverses the inner volume and separates, divides, and/or at least partially forms, a first cavity 215 and a second cavity 216. The first end 212 of the housing 211 is substantially open and is in communication with the first cavity 215. Similarly, the second end 213 of the housing 211 is substantially open and is in communication with the second cavity 216. In this manner, a first portion of the electronics assembly 220 can be inserted through the open first end 212 to be at least partially disposed within the first cavity 215 and a second portion of the electronics assembly 220 can be inserted through the open second end 213 to be at least partially disposed within the second cavity 216. Moreover, the inner wall 217 defines an opening 218 that extends therethrough such that the first cavity 216 and the second cavity 216 are at least partially in communication. As described in further detail herein, the opening 218 can receive a portion of the electronics assembly 220, which in turn, can electrically connect the first portion of the electronics assembly 220 to the second portion of the electronics assembly 220.

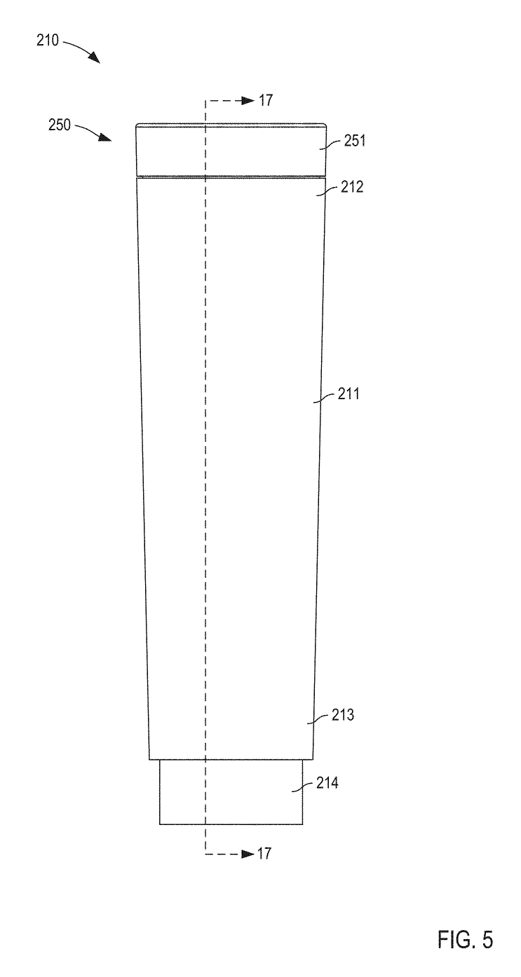

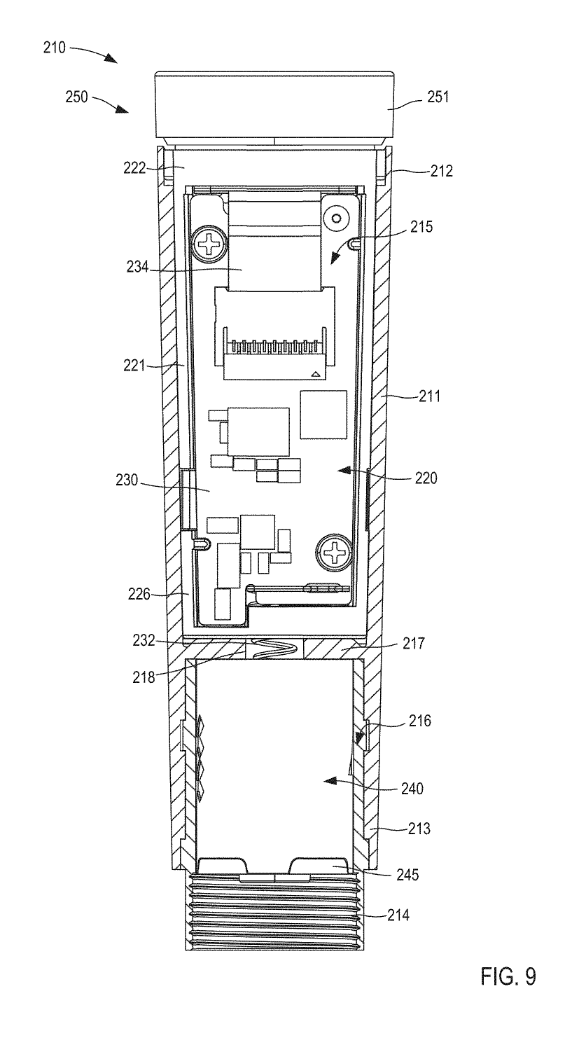

As shown in FIGS. 5, 6, and 9, the second end 213 of the housing 211 includes and/or is coupled to a coupling portion 214. For example, in some embodiments, the coupling portion 214 can be at least partially disposed within the second cavity 217 to fixedly couple to the second end 213 (e.g., via a press fit, interference fit, adhesive, ultrasonic weld, and/or the like). The coupling portion 214 includes and/or can form a set of threads disposed along an inner surface thereof (see e.g., FIG. 9). In this manner, the coupling portion 214 can selectively engage the second portion 270 of the device 200 to at least temporarily form a threaded coupling between the first portion 210 to the second portion 270 (see e.g., FIGS. 2-4).

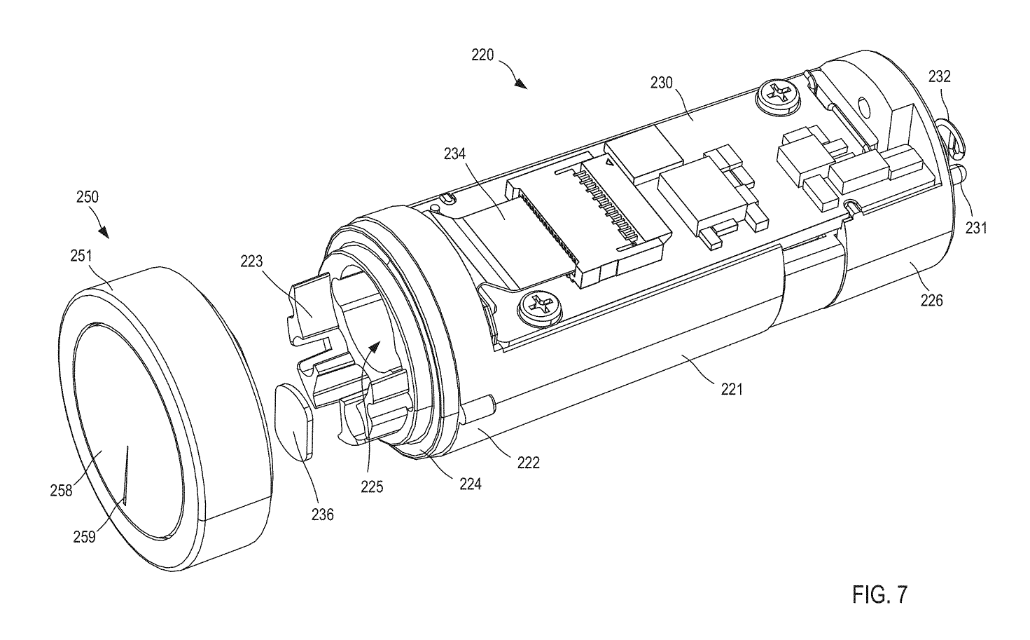

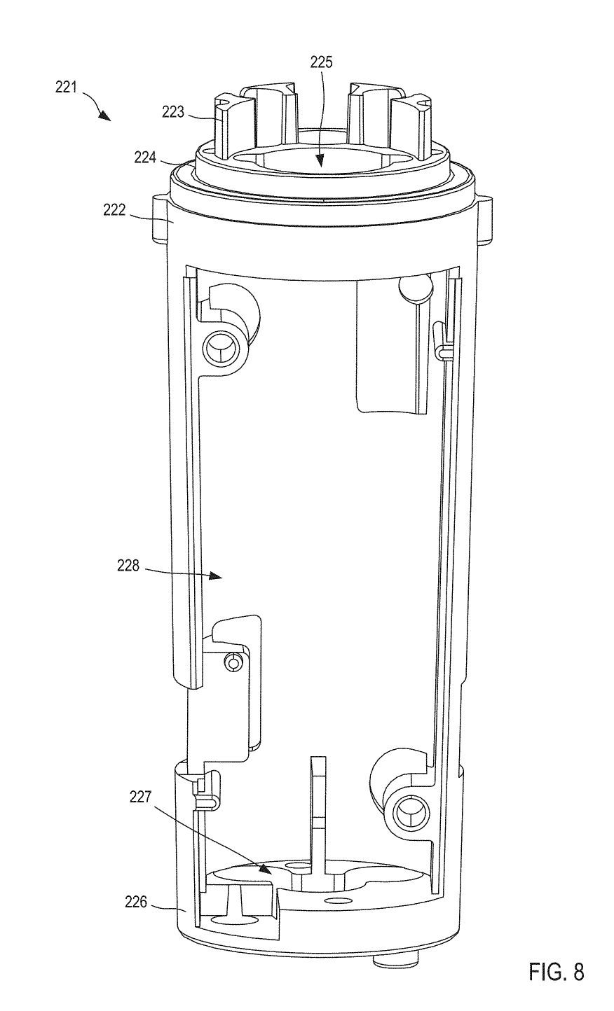

The electronics assembly 220 included in the first portion 210 of the device 200 can be any suitable configuration. In addition, the electronics assembly 220 can include any suitable structure, compute device, and/or electric/electronic component. For example, as shown in FIGS. 6-13, the electronics assembly 220 includes a housing 221, a printed circuit board (PCB) 230, and a battery assembly 240. The housing 221 of the electronics assembly 220 has a first end portion 222 and a second end portion 226 and defines a cavity 228. The first end portion 222 of the housing 221 includes a set of protrusions 223 and a track 224, as shown in FIGS. 7 and 8. In some embodiments, the protrusions 223 and the track 224 can be placed in contact with a portion of the wheel assembly 250 to facilitate a coupling between the housing 221 and the wheel assembly 250 (e.g., via a mechanical fastener, press fit, friction fit, adhesive, and/or the like) and/or to form or define a surface along which a portion of the wheel assembly 250 rotates. The first end portion 222 of the housing 221 also defines and/or forms a recess 225 configured to receive a portion of the wheel assembly 250 when the wheel assembly 250 is coupled to the housing 221, as described in further detail herein. The second end portion 226 of the housing 221 defines one or more openings configured to extend through an end surface of the housing 221 (e.g., a bottom end surface, as shown in FIG. 8). The cavity 228 of the housing 221 is configured to receive and/or house at least a portion of the PCB 230. More specifically, the PCB 230 can disposed within the cavity 228 such that a portion of the PCB 230 extends through the openings 227 defined by the second end portion 226, as described in further detail herein.

The housing 221 of the electronics assembly 220 is configured to be disposed and/or housed within the first cavity 215 of the housing 211 of the first portion 210 (see e.g., FIG. 9). In some embodiments, the housing 221 of the electronics assembly 220 can include one or more tabs, protrusions, and/or surfaces that can be placed in contact with an inner surface of the housing 211 of the first portion 210 to align the housing 221 therein such that the housing 221 is disposed in a predetermined orientation. In some embodiments, at least a portion of an outer surface of the housing 221 of the electronics assembly 220 can be placed in contact with the inner surface of the housing 211 of the first portion 210 to form and/or define a friction fit or the like therebetween. In this manner, the housing 221 of the electronics assembly 220 can be at least temporarily retained within the first cavity 215 of the housing 211 of the first portion 210. As described in further detail herein, the arrangement of the housing 221 of the electronics assembly 220 within the first cavity 215 can be such that a portion of the PCB 230 extends through the opening 218 defined by the inner wall 217 of the housing 211, as shown in FIG. 9.

The PCB 230 of the electronics assembly 220 can be any suitable printed circuit board and/or printed circuit board assembly that includes and/or that is electrically coupled to any suitable electric and/or electronic component. For example, the PCB 230 can include at least a processor and a memory. The processor can be, for example, a general-purpose processor (GPP), a central processing unit (CPU), an accelerated processing unit (APU), and/or the like. The memory can be, for example, a random access memory (RAM), a memory buffer, a hard drive, a solid-state drive (SSD), a read-only memory (ROM), an erasable programmable read-only memory (EPROM), a flash memory, and/or the like. In some embodiments, the processor and/or memory can be included in an application specific integrated circuit (ASIC) and/or the like. In some embodiments, the memory stores instructions to cause the processor to execute modules, code, processes, and/or functions associated with detecting a rotation of a portion of the wheel assembly 250 and/or determining a measurement and/or dimension associated with the rotation of the portion of the wheel assembly 250, as described in further detail herein.

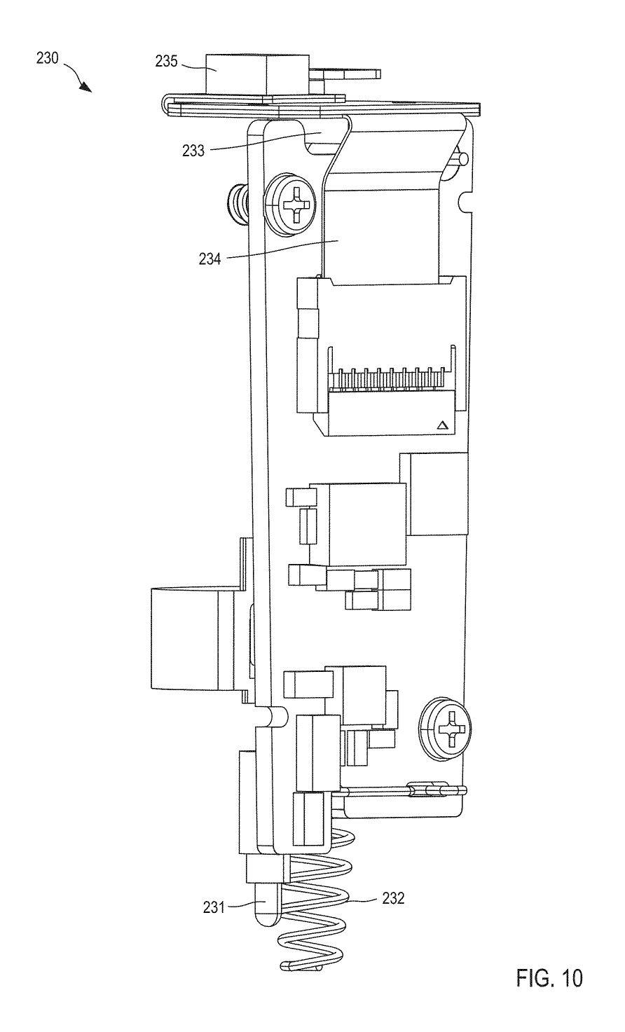

As shown in FIGS. 9 and 10, the PCB 230 also includes a first electrical contact 231, a second electrical contact 232, a magnetic sensor 233, a bus 234, an optical output device 235, and a lens 236 (see e.g., FIG. 7). The first electrical contact 231 can be, for example, a positive electrical contact or terminal and the second electrical contact 231 can be, for example, a negative electrical contact or terminal. The first electrical contact 231 and the second electrical contact 232 are configured to electrically couple the PCB 230 to the battery assembly 240. More specifically, the PCB 230 can be disposed within the cavity 228 of the housing 221 such that at least a portion of the electrical contacts 231 and 232 extend through the opening 227 defined by the second end portion 226. Similarly, the housing 221 can be disposed within the first cavity 215 of the housing 211 such that the electrical contacts 231 and 232 extend through the opening 218 defined by the inner wall 217 of the housing 211. Thus, the electrical contacts 231 and 232 can selectively engage the battery assembly 240 such that electric power can flow from the battery assembly 240 to the PCB 230.

The magnetic sensor 233 included in the PCB 230 is configured to produce an electric and/or electronic signal in response to an applied magnetic field and/or in response to a change in an applied magnetic field. Moreover, the bus 234 (e.g., an electric and/or electronic connector or the like) can be electrically connected to the magnetic sensor 233 and configured to send one or more signals between the magnetic sensor 233 and, for example, the processor or the like. The magnetic sensor 233 can be any suitable magnetic sensor such as, for example, a hall magnetic sensor, and/or the like. In some embodiments, the magnetic sensor 233 can be configured to detect and/or sense one or more changes in a magnetic field generated by a magnetic member 257 of the wheel assembly 250. As such, the processor can receive from the magnetic sensor 233 (e.g., via the bus 234 or the like) one or more signals indicative of data associated with the one or more changes, which in turn, can be used to determine an amount and/or characteristics of a rotation of at least a portion of the wheel assembly 250, as described in further detail herein.

The optical output device 235 and the lens 236 can be and suitable configuration. In some embodiments, the optical output device 235 can be a laser configured to project a beam of light, which in turn, is focused, filtered, directed, and/or otherwise passed through the lens 236. For example, in some embodiments, the lens 236 can be configured to focus and/or direct a beam of light produced by the optical output device 235 through a slit or opening 259 defined by an end cap 258 of the wheel assembly 250 (e.g., the lens 236 can be disposed within a recess or the like defined by the end cap 258). In some instances, the beam of light can be projected onto a surface to provide an indication associated with a point of contact between a portion of the wheel assembly 250 and the surface. In such instances, for example, a user can align the beam of light (e.g., the output of the optical output device 235) with a starting point of a line to be measured and can use the beam of light as a guide or the like to follow the line to an ending point thereof. In other embodiments, the optical output device 235 can produce a beam of light or the like which can be used to determine one or more measurements and/or dimensions (e.g., via a light sensor configured to sense and/or detect reflected light or the like).

In still other embodiments, the optical output device 235 can be used to project data or the like (e.g., via an illuminated graphical image) on a surface. For example, in some embodiments, the optical output device 235 can be configured to project (via a beam of light) a grid or a set of indicators at predetermined intervals (e.g., even intervals or gradients). In some embodiments, the optical output device 235 can be configured to project a measurement and/or dimension of an object dimensioned using the device 200. In other embodiments, the optical output device 235 can be configured to provide an indicator or the like indicative of a status of at least the first portion 210 of the device 200. Such a status can be associated with, for example, a powered on state, a powered off state, a battery charge level (e.g., low battery power indicator), an error state, and/or any other suitable status of at the first portion 210 of the device 200.

Although not shown herein, the PCB 230 and/or the electronics assembly 220 can include any suitable communication interface or the like (e.g., a network interface card) configured to send and/or receive data via, for example, a network. For example, the communication interface can include one or more wired and/or wireless interfaces, such as, for example, Ethernet interfaces, optical carrier (OC) interfaces, and/or asynchronous transfer mode (ATM) interfaces. In some embodiments, the communication interface can be, for example, a network interface card and/or the like that can include, for example, an Ethernet port and/or one or more wireless radios (e.g., a WiFi® radio, a Bluetooth® radio, a Near Field Communication (NFC) radio, etc.). In this manner, the PCB 230 and/or the electronics assembly 220 can be placed in electronic communication with one or more external electronic devices. For example, in some embodiments, the PCB 230 and/or the electronics assembly 220 can be in electronic communication with a personal computer (PC), a laptop, a mobile device, a smartphone, a wearable electronic device, a “smart” device or appliance, etc. via a wireless connection or network and an application running on the device.

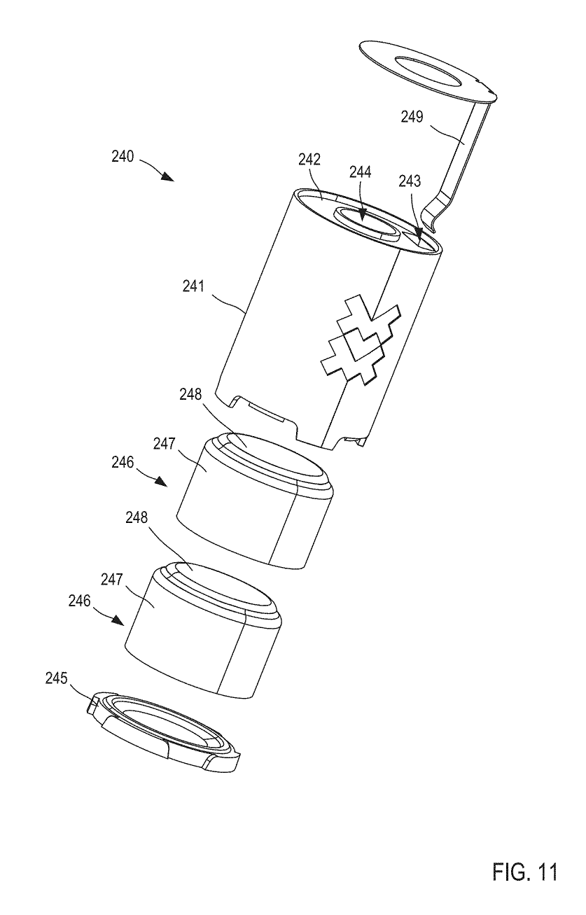

The battery assembly 240 (or battery pack) can be any suitable shape, size, and/or configuration. For example, as shown in FIGS. 11-13, the battery assembly 240 includes a casing 241, an end cap 245, one or more batteries 246, and a contact member 249. The casing 241 has a first end portion that includes an end surface 242 and a second end portion that is substantially open. The end surface 242 defines a first opening 243 configured to receive a portion of the contact member 249 and a second opening 244 configured to receive a portion of the second electrical contact 232 of the PCB 230, as described in further detail herein. The batteries 246 can be any suitable type and/or configuration. For example, in this embodiment, the battery assembly 240 include two coin batteries (button cells) or the like. Each battery 246 includes a positive terminal 247 formed by or along a bottom surface and side surfaces of the battery 246 and a negative terminal 248 formed by or along a top surface. The batteries 246 are configured to be disposed within the casing 241 such that the negative terminal 248 of the first battery 246 is adjacent to and/or aligned with the second opening 244 of the end surface 242, while the negative terminal 247 of the second battery 246 is in contact with the bottom surface or positive terminal of the first battery 246 (e.g., the batteries 246 are in series), as shown in FIG. 13. Moreover, the end cap 245 can be pressed into the open end of the casing 241 to at least temporarily retain the batteries 246 within the casing 241 (e.g., the end cap 245 and a portion of the casing 241 for a friction fit, press fit, and/or the like). In other words, the battery assembly 240 can be configured as and/or can form a battery pack or the like.

The arrangement of the batteries 246 within the casing 241 is such that the second electrical contact 232 of the PCB 230 extends through the second opening 244 of the end surface 242 of the casing 241 to contact the negative terminal of the battery 246 adjacent to the end surface 242. In this manner, the PCB 230 is electrically connected to the negative terminals 248 of the batteries 246. As shown in FIG. 13, a portion of the contact member 249 extends through the first opening 243 of the end surface 242 to be disposed within the casing 241. More specifically, an end portion of the contact member 249 can be biased and/or bent such that the end portion of the contact member 249 is in contact with the positive terminal 247 of either battery 246 (e.g., in this embodiment, the contact member 249 is in contact with the battery 246 adjacent to the end cap 245). Moreover, a portion of the contact member 249 is maintained outside of the casing 241. For example, in some embodiments, the contact member 249 can form a ring or the like disposed within a recess defined by the end surface 242 of the casing 241, as shown in FIGS. 11 and 13. Thus, the first electrical contact 231 of the PCB 230 can extend through the openings 227 and 218 defined by the housing 221 and the inner wall 217 of the housing 211, respectively, and into contact with the contact member 249. In this manner, the PCB 230 is electrically connected to the positive terminals 247 of the batteries 246. Accordingly, with the PCB 230 in electrical contact with the positive terminal(s) 247 and the negative terminal(s) 248, electric current and/or power can flow from the battery assembly 240 to the PCB 230 to power the electric and/or electronic components thereof (e.g., when in a powered on state). Moreover, the arrangement of the battery assembly 240 can allow the electrical contacts (e.g., positive and negative terminals) to be disposed on one side, as shown in FIG. 13.

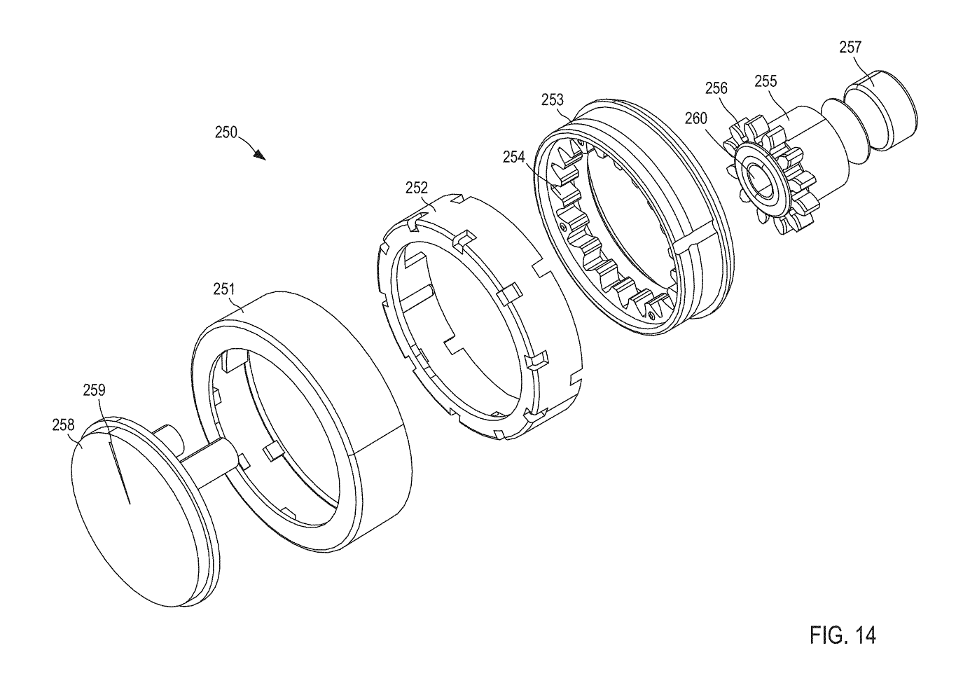

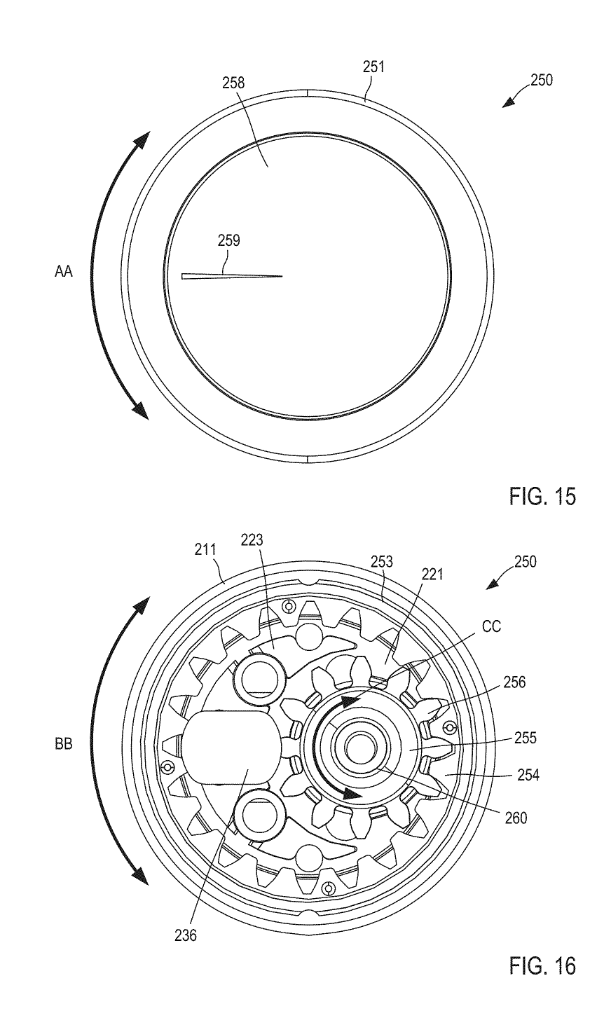

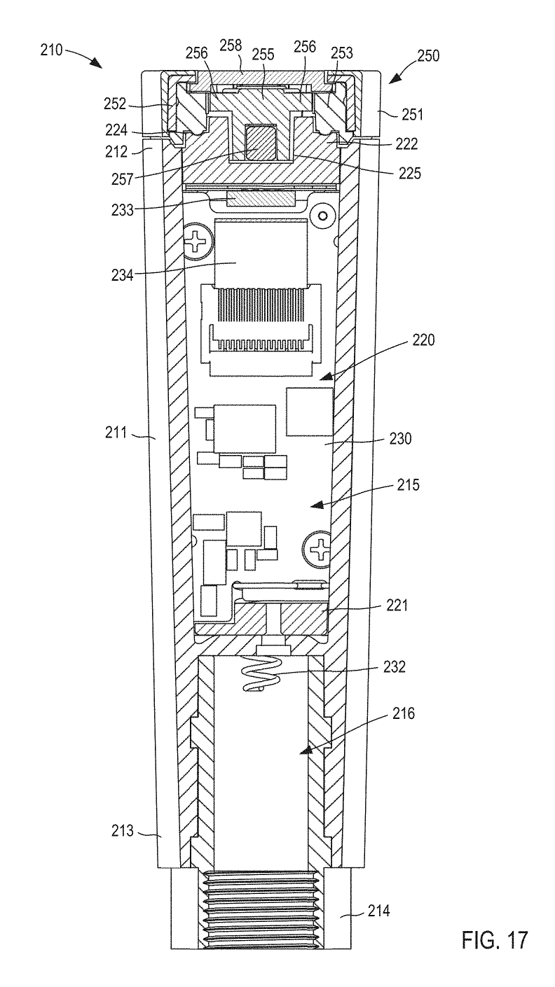

The wheel assembly 250 can be any suitable shape, size, and/or configuration. For example, as shown in FIGS. 14-17, the wheel assembly 250 includes a contact wheel 251, a coupling ring 252, a gear ring 253, a pinion 255, a magnetic member 257, and an end cap 258. As described above, the arrangement of the wheel assembly 250 is such that at least a portion of the wheel assembly 250 is rotatably coupled to and/or rotatably disposed about the first end 222 (e.g., a first end portion) of the housing 221 of the electronics assembly 220. For example, the arrangement of the wheel assembly 250 is such that the gear ring 253 is in contact with and configured to rotate along the track 224 (see e.g., FIGS. 16 and 17). The coupling ring 252 is coupled to an outer surface or portion of the gear ring 253 (e.g., via a press fit, friction fit, interference fit, one or more tabs, etc.) and is retained in a substantially fixed position and/or orientation relative thereto. Similarly, the contact wheel 251 is coupled to an outer surface or portion of the coupling ring 252 and is retained in a substantially fixed position and/or orientation relative thereto. The end cap 258 of the wheel assembly 250 is fixedly coupled to the protrusions 223 of the first end 222 of the housing 221 (e.g., via a mechanical fastener or the like) and selectively engages a portion of the gear ring 253. In this manner, the end cap 258 can maintain a coupling of the gear ring 253, coupling ring 252, and contact wheel 251 to the first end 222 of the hosing 221 while allowing the gear ring 253, coupling ring 252, and contact wheel 251 to rotate along the track 224, as indicated by the arrows AA and BB in FIGS. 15 and 16, respectively.

The contact wheel 251 can be any suitable shape, size, and/or configuration. In some embodiments, for example, the contact wheel 251 can be formed of a relatively soft material configured to facilitate and/or otherwise enhance grip and/or traction with a surface along which the contact wheel 251 moves (e.g., rolls). For example, the contact wheel 251 can be formed of a relatively soft material such as a plastic, rubber, silicone, and/or the like. Likewise, the contact wheel 251 can have and/or can include any suitable surface finish, tread, etc. that can enhance a grip and/or contact between a surface and the contact wheel 251. In some embodiments, the contact wheel 251 and/or any other suitable portion of the wheel assembly 250 can be removable, interchangeable, swappable, etc. For example, in some embodiments, the contact wheel 251 can have a size and/or can be formed of a material based at least in part on a surface that the contact wheel 251 is configured to move (e.g., roll) along. For example, in some embodiments, a contact wheel can have a first diameter that is associated with and/or configured to move along a relatively rough surface, while in other embodiments, a contact wheel can have a second diameter, smaller than the first diameter, which is associated with and/or configured to move along a relatively smooth surface. By way of another example, a contact wheel can be formed of a relatively soft material and/or a material with a relatively high coefficient of friction when the contact wheel is moved (e.g., rolled) along a smooth or slick surface such as glass or the like.

The pinion 255 of the wheel assembly 250 can be any suitable shape, size, and/or configuration. As shown in FIGS. 16 and 17, the pinion 255 is disposed within the recess 225 defined by the first end 222 of the housing 221 such that a set of gear 256 of the pinion 255 engage, mesh, and/or contact a set of gears 254 of the gear ring 253. For example, in some embodiments, the pinion 255 can define an opening 260 configured to receive a portion of the end cap 258 (e.g., a post or the like). Although not shown, the opening 260 further receives a mechanical fastener or the like configured to couple to the portion of the end cap 258. Thus, the arrangement of the wheel assembly 250 and the first end 222 of the housing 221 is such that the pinion 255 is disposed within the recess 225 of the first end 222 and is configured to rotate about an axis defined by the portion of the end cap 258 in response to a rotation of the gear ring 253. Expanding further, when the contact wheel 251 is rotated, for example, in response to being moved or rolled along a surface, the gear ring 253 is concurrently rotated along the track 224. The rotation of the gear ring 253 (indicated by the arrow BB in FIG. 16) results in a rotation of the pinion 255 (indicated by the arrow CC in FIG. 16).

The pinion 255 houses, includes, and/or is coupled to the magnetic member 257. For example, in some embodiments, the magnetic member 257 can be disposed within the opening 260 (FIG. 16) and coupled to an inner surface via, for example, an adhesive. In other embodiments, the magnetic member 257 can be integrally formed with the pinion 255 (e.g., via an over-mold or the like). Accordingly, the magnetic member 257 can be maintained in a fixed position relative to the pinion 255 such that when the pinion 255 is rotated in response to a rotation of the gear ring 253, the magnetic member 257 is similarly rotated (e.g., in the direction of the arrow CC in FIG. 16).

As shown in FIG. 17, disposing the pinion 255 in the recess 225 defined by the first end 222 of the housing 221 aligns and/or otherwise places the magnetic member 257 in a desired position relative to the magnetic sensor 233 of the electronics assembly 220. More specifically, the recess 225 can be defined in the first end 222 of the housing 221 in a position that is aligned with and/or adjacent to the magnetic sensor 233 and have any suitable depth or the like that results in a desired separation between the magnetic member 257 and the magnetic sensor 233, as shown in FIG. 17. In this manner, when the pinion 255 and magnetic member 257 are rotated within the recess 225 in response to a rotation of the contact wheel 251 (as described above), a magnetic field produced by the magnetic member 257 is also rotated and/or at least measurably altered.

As described above, the magnetic sensor 233 (e.g., a hall magnetic sensor or the like), is configured to sense, determine, and/or otherwise electrically interact with the magnetic field produced by the magnetic member 257. For example, in some embodiments, the magnetic sensor 233 can be configured to produce a signal or voltage in response to the magnetic field being within a predetermined distance from the magnetic sensor 233 and/or being in a predetermined orientation relative to the magnetic sensor 233. Accordingly, a point and/or portion of the magnetic member 257 can form and/or otherwise act as a reference point, which the magnetic sensor 233 can track and/or detect based on one or more characteristics associated with the magnetic field produced by the magnetic member 257. Moreover, when the one or more characteristics associated with the magnetic field satisfy a criterion (or a set of criteria), the magnetic sensor 233 can output a voltage or signal that is sent to the processor via the bus 234. Such criterion or criteria can be, for example, strength, orientation, polarity, proximity, and/or the like of the magnetic field and/or the magnetic member 257.

Based on receiving the signals and/or voltage output from the magnetic sensor 233, the processor of the electronics assembly 220 can determine, for example, a number of rotations of the magnetic member 257 and in turn, a number of rotations of the pinion 255. Furthermore, with the gears 256 of the pinion 255 engaging the gears 254 of the rotation ring 253, the processor can determine a number of rotations associated with the gear ring 253, and thus, the contact wheel 251 based on, for example, a diameter of the pinion 255, the gear ring 253, and/or the contact wheel 251; a gear ratio between the pinion 255 and the gear ring 253; a determined rotational velocity of the pinion 255 and/or magnetic member 257; and/or any other suitable characteristic, relationship, data, etc. Said another way, the processor and/or the electronics assembly 220 can determine, for example, a number of rotations of the contact wheel 251 (indicated by the arrow AA in FIG. 15) as the contact wheel 251 is moved (e.g., rolled) along a surface based on the magnetic sensor 233 sensing and/or detecting changes in a magnetic field associated with a corresponding rotation of the pinion 255 (indicated by the arrow CC in FIG. 16). Accordingly, as described above with reference to the device 100, the electronics assembly 220 can determine and/or calculate a measurement and/or dimension associated with a path on the surface along which the contact wheel 251 is moved (e.g., rotated). That is to say, the electronics assembly 220 can determine and/or calculate a distance associated with the path on the surface along which the contact wheel 251 moves.

In some embodiments, the use of the magnetic member 257 and magnetic sensor can allow for an accurate and/or precise measuring or dimensioning. For example, in some embodiments, the electronics assembly 220 (e.g., a processor or the like) can determine a measurement within about 1.0 millimeter (mm), about 0.9 mm, about 0.8 mm, about 0.7 mm, about 0.6 mm, about 0.5 mm, about 0.4 mm, about 0.3 mm about 0.2 mm, about 0.1 mm, or less. Moreover, unlike some known measuring wheels using, for example, optical tracking or the like, the use of the magnetic member 257 and magnetic sensor can allow for bi-directional operation in which rotation of the contact wheel 251 in a first direction results in an increase in a value of a dimension or measurement and rotation of the contact wheel 251 in a second direction, opposite the first direction, results in a decrease in the value of the dimension or measurement. That is to say, in some instances, moving the contact wheel 251 along a surface in a first direction results in a positive or increasing measurement and moving the contact wheel 251 along the surface in a second direction, opposite the first direction, results in a negative or decreasing measurement. Thus, for example, if a user moves the contact wheel 251 beyond a desired point along a surface (thereby resulting in a measurement that is greater than the dimension of what is being measured), the user can move the contact wheel 251 in a substantially opposite direction (i.e., a reverse direction) to the desired point along the surface, which in turn, reduces the value of the measurement such that the measurement accurately reflects the dimension of what is being measured.

Although not shown in FIGS. 2-17, the electronics assembly 220 can include any suitable electrical and/or electronic component such as, for example, one or more a sensor(s) (e.g., a six-axis or nine-axis position sensor or gyroscope), a global positioning system (GPS), a compass, and accelerometer, and/or the like. In such embodiments, the user can move the contact wheel 251 along a surface to obtain a measurement and/or dimension thereof. In some instances, the GPS, compass, gyroscope, and/or the like can be configured to provide data associated with the movement of the device 200 and based on the data, the electronic system 220 can, for example, correct and/or adjust a value of the measurement and/or dimension of the surface to offset deviations and/or variances associated with the movement of the device 200. For example, in some instances, a user may desire to take a measurement and/or dimension along a surface (e.g., a wall) in a substantially straight line (e.g., in a horizontal direction). In such instances, deviations and/or variances in the movement of the contact wheel 251 along the surface (e.g., in a vertical direction) that otherwise can result in an inaccurate measurement and/or dimensioning of the surface can be corrected and/or adjusted for by the electronics assembly 220 based on data received from the GPS, compass, gyroscope, and/or any other suitable sensor. Likewise, in some instances, the electronics assembly 220 can be configured to adjust and/or correct for deviations and/or variances associated with, for example, moving along a rough surface or the like that might otherwise result in loss of traction and/or an inaccurate measurement.

Although not shown in FIG. 2, in some embodiments, the first portion 210 of the device 200 can include an input and/or interface that can be manipulated to send a signal to the electronics assembly 220 indicative of an instruction to perform one or more processes associated with making such corrections and/or adjustments. In other instances, the electronics assembly 220 can determine a direction and/or orientation of the device 200 based on data received from one or more sensors (e.g., the GPS, compass, gyroscope, etc.). As such, the electronics assembly 220 (e.g., the processor) can automatically determine characteristics associated with the measurement. For example, based on data received from the sensors, the electronics assembly 220 can automatically determine that a measurement is associated with a height, width, and/or length of an object. In still other instances, a user can manipulate an input (e.g., a button, toggle, touch-sensitive surface, etc.), which in turn, can send a signal to the electronics assembly 220 indicative of an instruction to store, at least temporarily, one or more measurements which can be presented as, for example, an ordered list or the like.

Although not shown herein, the electronics assembly 220 can be in electronic communication with one or more output devices and/or one or more external electronic devices. For example, although not shown, the electronics assembly 220 and/or any suitable portion of the device 200 can include an output such as a display or the like. In such embodiments, the processor or the like of the electronics assembly 220 can calculate and/or determine a measurement and/or dimension and can send one or more signals to the display indicative of an instruction to graphically represent data indicating the measurement and/or dimension. In other embodiments, the processor can send one or more signals to a communication interface such as a network interface card or the like and in response, the communication interface can send data associated with the measurement and/or dimension to one or more external electronic devices (e.g., a PC, laptop, smartphone, wearable electronic device, etc.). Furthermore, a user can access the data on the external electronic device(s) via a PC or mobile application, a web browser and the Internet, and/or the like. In some instances, such external electronic devices (e.g., a smartphone) can be configured to present any suitable data associated with the device 200 and/or a status thereof (e.g., a measurement or dimension, an operational state such as “powered on” or “powered off,” a battery charge level, etc.). In some instances, such external electronic devices can provide and/or can be configured to present to a user an interface allowing the user to order and/or purchase parts and/or supplies associated with the device (e.g., batteries, pencil lead, ink cartridges, attachment accessories (second portions 270 of any suitable configuration), and/or the like).

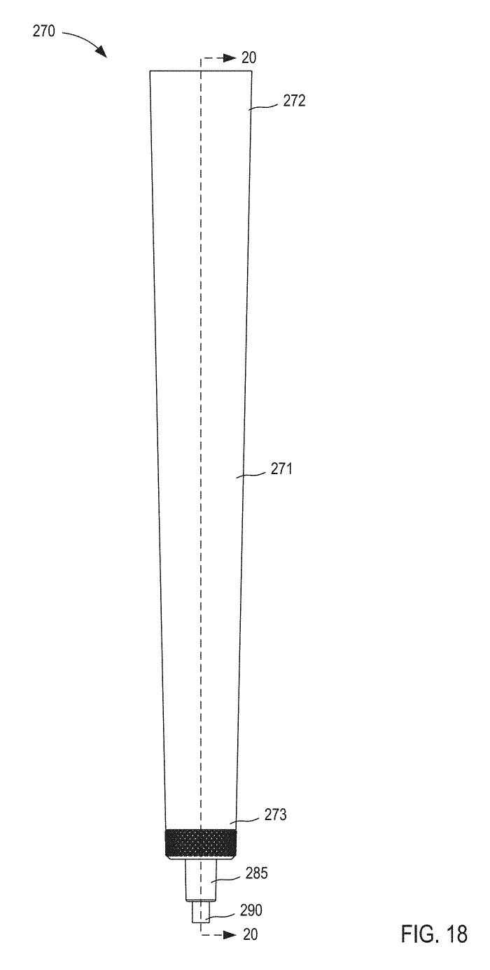

Referring to FIGS. 18-21, the second portion 270 of the device 200 is configured to removably couple to the first portion 210 of the device 200. The second portion 270 can be any suitable shape, size, and/or configuration. In some embodiments, for example, the second portion 270 of the device 200 can have a size and/or shape that is substantially similar to at least a portion of some known writing utensils (e.g., pens, pencils, etc.). Moreover, the second portion 270 can be arranged as any suitable writing utensil, stylus, accessory, and/or the like. For example, in the embodiment shown in FIGS. 18-21, the second portion 270 of the device 200 is configured and/or arranged as a pencil. It should be understood, however, that the second portion 270 is described hereinbelow by way of example and not limitation.

As shown, the second portion 270 of the device 200 includes a housing 271, a first end cap 276, a second end cap 285, a holder 280, and a writing instrument 290. The housing 271 of the second portion 270 has a first end 272 (e.g., a first end portion) and a second end 273 (e.g., a second end portion). As described above with reference to the first portion 210 of the device 200, the second portion 270 of the device 200 can have a size and/or shape that is suitable for single-handed operation and/or the like. The first end 272 of the housing 271 included in the second portion 270 is configured to removably couple to the second end 213 of the housing 211 included in the first portion 210. For example, the first end 272 of the housing 271 includes and/or is coupled to the first end cap 276 (see e.g., FIGS. 4, 19, and 20). The first end cap 276 can include, for example, a set of threads or the like configured to form a threaded coupling with the coupling portion 214 of the housing 211 of the first portion 210 (described above). In this manner, the first portion 210 can be threaded onto and/or otherwise coupled to the second portion 270 to collectively form the device 200 (FIGS. 2 and 3). Although described above a forming a threaded coupling, in other embodiments, the first portion 210 and the second portion 270 can be removably coupled via any suitable coupling method such as, for example, a snap fit, a friction fit, an interference fit, and/or any suitable releasable coupling therebetween.

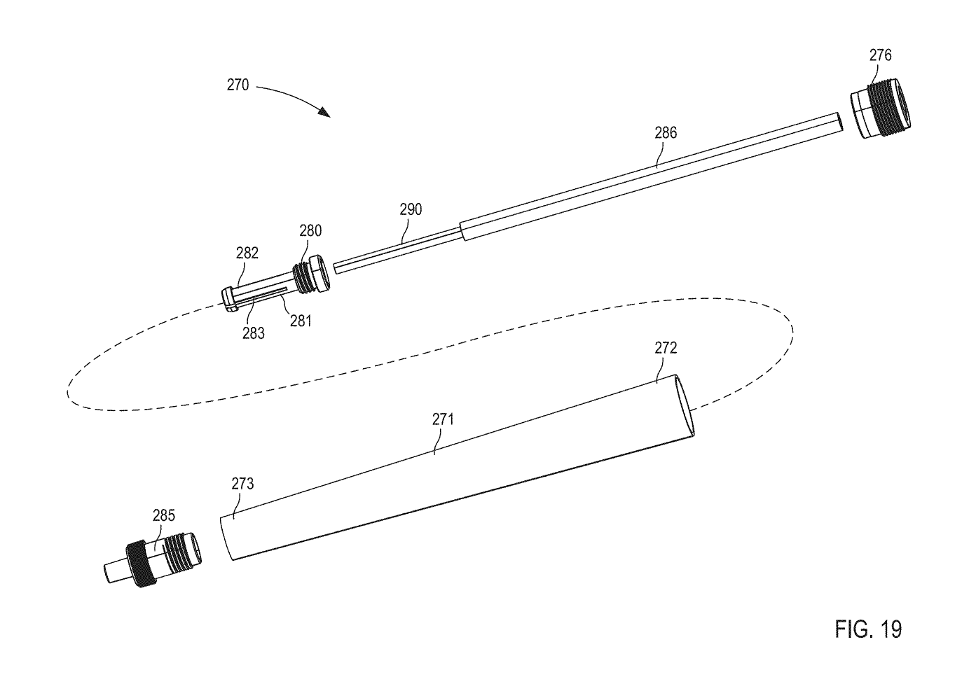

The second end 273 of the housing 271 can any suitable shape, size, and/or configuration. For example, in some embodiments, the second end 273 of the housing 271 can have a diameter that is smaller than a diameter of the first end 272 such that the housing 271 forms a taper or the like. The second end 273 is removably coupled to a second end cap 285. For example, in some embodiments, the second cap 285 and the second end 273 of the housing 271 can form a threaded coupling or the like to at least temporarily couple the second end cap 285 to the second end 273 of the housing 271. The second end cap 285 can be any suitable configuration. For example, as shown in FIGS. 18 and 19, the second end cap 285 can include an outer surface having any suitable surface finish such as, for example, a knurled finish, or the like. In some embodiments, such a surface finish can increase the ergonomics of the second portion 270. In other embodiments, the second end cap 285 can include an outer surface that includes, for example, one or more pads, grips, cushions, and/or the like.

The holder 280 is coupled to an inner portion of the housing 271 via any suitable coupling. For example, as shown in FIGS. 19-21, the holder 280 can form a threaded coupling with an inner portion of the housing 271 at or near the second end 273 of the housing 271. The holder 280 can be any suitable shape, size, and/or configuration. For example, as shown in FIGS. 19-21, the holder 280 includes a first arm 281 and a second arm 282, and defines a passageway 284 extending through the holder 280. The passageway 284 is configured to adjustably receive at least a portion of the writing instrument 290 therein. Moreover, the passageway 284 can receive a portion of a sheath 286 extending between the holder 280 and the first end cap 276 that is configured to receive and/or house at least a portion of the writing instrument 290 (e.g., to protect the writing instrument 290 and/or to otherwise support the writing instrument 290). As described above, in this embodiment, the second portion 270 is configured and/or arranged as a pencil and thus, the writing instrument 290 can be, for example, and elongate piece of graphite or graphite mixed with a clay binder or the like (i.e., pencil lead—“lead,” when used in this context is not to be confused with the element “lead” (Pb)).

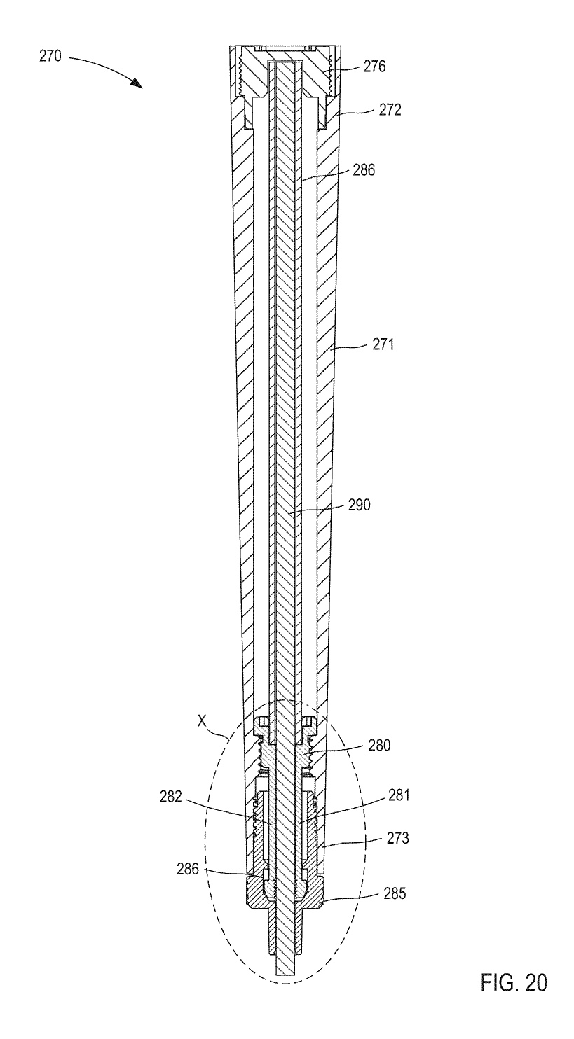

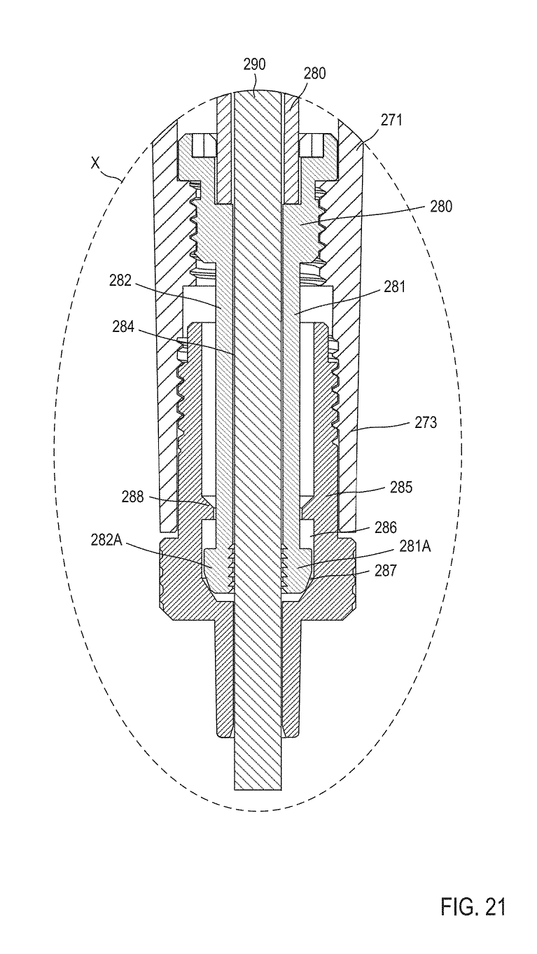

As shown in FIGS. 20 and 21, a portion of the holder 280 is selectively disposed within the second end cap 285. The second end cap 285 includes an inner surface 286 having and/or forming a tapered portion 287 and a protrusion 288. In some embodiments, the protrusion 288 can be, for example, a circumferential protrusion, tab, ridge, bump, etc. In other embodiments, the protrusion 288 need not be circumferential. As shown, at least a portion of the first arm 281 and at least a portion of the second arm 282 are disposed within an inner volume defined by the inner surface 286 of the second end cap 285. More specifically, the first arm 281 and the second arm 282 are partially disposed within the holder 280 such that a flared end 281A of the first arm 281 and a flared end 282A of the second arm 282 are disposed in a space defined between the protrusion 288 and the tapered portion 287 of the inner surface 286. For example, the holder 280 can define a slot 283 extending between the first arm 281 and the second arm 282 which can, for example, allow the first arm 281 and the second arm 282 to bend, flex, and/or deform in response to an applied for. Thus, in some instances, the first arm 281 and the second arm 282 can be bent and/or flexed such that a distance therebetween is reduced (e.g., when the writing instrument 290 is not disposed within the passageway 284). In this manner, a diameter and/or perimeter of the both flared ends 281A and 282A can be smaller than, for example, an inner diameter, and/or inner perimeter of the protrusion 288. Thus, the flared ends 281A and 282A can be disposed within the space defined between the protrusion 288 and the tapered surface 287.

Conversely, when a portion of the writing instrument 290 is disposed within the passageway 284, the writing instrument 290 can reduce and/or substantially prevent movement of the first arm 281 toward the second arm 282. In some embodiments the writing instrument 290 can exert a constant force or pressure on an inner portion of the first arm 281 and the second arm 282 that is operable in biasing and/or pushing the first arm 281 and the second arm 282 outwardly (e.g., increasing a distance between the first arm 281 and the second arm 282). Thus, in some embodiments, when the writing instrument 290 is disposed within the passageway 284, the flared ends 281A and 282A can be maintained within the space between the protrusion 288 and the tapered surface 287, as shown in FIGS. 20 and 21.

In some embodiments, the threaded coupling of the second end cap 285 to the second end 273 of the housing 271 can allow, for example, the second end cap 285 to be advanced along the threads of the second end 273 of the housing 271 such that the second end cap 285 is moved in an axial direction closer to or further from an end surface of the housing 271 (the second end 273). As shown in FIG. 21, in some instances, the movement of the second end cap 285 relative to the holder 280, for example, can place the flared ends 281A and 282A in contact with the tapered surface 287 of the second end cap 285. In this manner, a force is exerted on the first arm 281 and the second arm 282 that is sufficient to deform the first arm 281 and the second arm 282. However, with the writing instrument 290 disposed within the passageway 284, the force exerted on the flared ends 281A and 282A can result in, for example, the first arm 281 and the second arm 282 exerting a clamping force on the writing instrument 290 sufficient to maintain the writing instrument 290 (e.g., pencil lead) in a fixed position relative to the second portion 270. Thus, the second portion 270 can be used, for example, as a pencil whether the first portion 210 of the device 200 is coupled thereto or not. In some instances, the first portion 210 can be used to take and/or determine one or more measurements and/or dimensions, and conveniently coupled thereto, the second portion 270 can be used to, for example, write notes associated with the measurements and/or dimensions, and/or any other suitable writing and/or drawings.

Although the writing instrument 290 is described above a being, for example, pencil lead, in other embodiments, the writing instrument 290 can be any suitable configuration. For example, in some embodiments, the second portion 270 can include a writing instrument 290 configured as, for example, a ballpoint pen, fountain pen, marker, colored pencil, crayon, chalk, and/or any other suitable writing instrument and/or utensil. In such embodiments, a user can manipulate the device 200 by placing the writing instrument 290 in contact with a medium and moving the device to write and/or otherwise mark the medium. For example, in some instances, a user can manipulate the device 200 to write, using the writing instrument 290, information associated with one or more dimensions determined by the device 200. In other instances, the user can manipulate the device 200 to make any suitable mark on a medium using the writing instrument 290 (e.g., the writing is not limited to writing information associated with the one or more dimensioned determined by the device 200). In this context, a medium can include any suitable surface on which a person can write. A non-exhaustive list of examples of a medium can include, for example, paper or other article commonly used for writing or printing, wood, cardboard, drywall, plaster, glass, cloth, a portion of the user's body such as the user's hand, the surface being measured, and/or any other suitable surface.

While the writing instrument 290 is described above as being used for writing and/or otherwise making a mark(s) on a medium, in other embodiments, a device can include a writing instrument configuration as a stylus or the like, which can be placed in contact with a touch-sensitive display of a computing device or the like. As such, the user can move the stylus (e.g., writing instrument 290) along the touch-sensitive display, which in turn, can result in writing being graphically represented on the display and/or can otherwise result in user-inputs into the computing device. In other words, the writing instrument 290, when configured as a stylus, can be substantially similar in at least function to known styluses.

While various embodiments have been described above, it should be understood that they have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made. Although various embodiments have been described as having particular features and/or combinations of components, other embodiments are possible having a combination of any features and/or components from any of embodiments as discussed above.

Although not shown herein, the embodiments described above can be used with any suitable external device. For example, in some instances, the device 200 can be used with an external electronic device (e.g., a computing device such as a personal computer, a laptop, a tablet, a workstation, etc.) and configured to send data to and/or receive data from the external electronic device. In some instances, such an external device can be used to create, calculate, and/or produce digital and/or virtual maps of any suitable surface based on measurements and/or dimensions (and or any suitable data) received from the electronics assembly 220. In some embodiments, one or more sensor(s) (e.g., a three-axis, a six-axis, or a nine-axis motion sensor) can provide the electronics assembly 220 with data associated with the movement of the device 200 that captures the path of the movement at predetermined intervals. This data can be synchronized with the distance measurement (associated with movement of the contact wheel 251 along the surface) calculated and/or determined by the electronics assembly 220 and can be cross-referenced with data associated with an accurate distance and direction measurement (e.g., based on known or predetermined information and/or data). The synchronized data can be used to create a point trail in two-dimensional space or in three-dimensional space which can be extrapolated to obtain a curved path that filters noise (e.g., Bézier curve). The two-dimensional and three-dimensional path (e.g., point trail) can be visualized, saved, and converted to any suitable format (e.g., a format compatible with one or more Computer Aided Design program(s)). In some embodiments, the synchronized data enables the electronics assembly 220 to preform error corrections due to unlevelled and/or wobbly movement of the contact wheel 251.

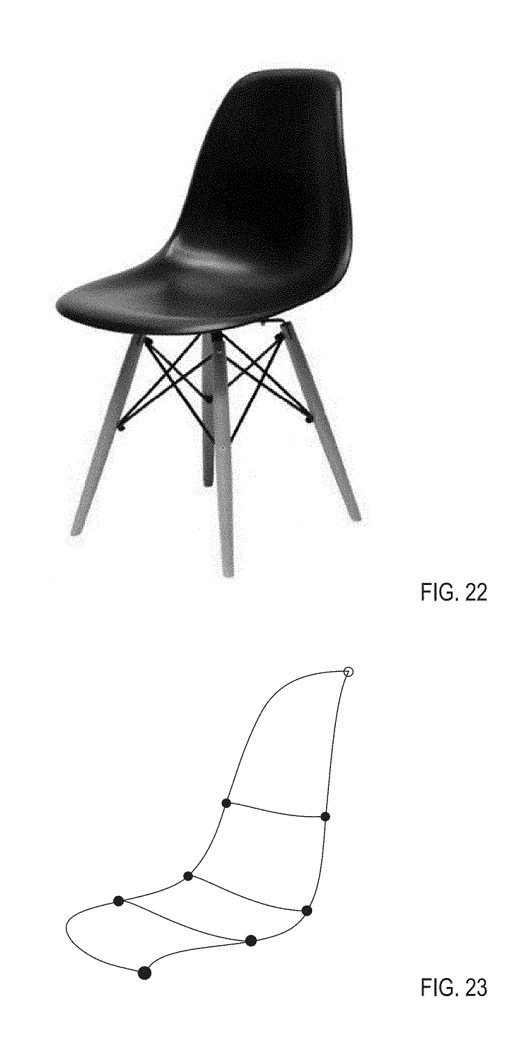

For example, FIGS. 22 and 23 illustrate a chair and a three-dimensional point trail calculated and/or determined in response to movement of the contact wheel 251 along a surface of the chair, respectively, according to an embodiment. As described above, in some instances, the contact wheel 251 can be moved along the surface of the chair in a desired path and one or more motion sensors can capture data, at predetermined intervals (e.g., at predetermined points in space and/or at predetermined time intervals), associated with the path of the movement of the device 200 (or contact wheel 251) which is synchronized with the distance measurement obtained from the electronic system 220. Thus, the data captured by the one or more motion sensors can be used to extrapolate the point trail to obtain, calculate, define, and/or determine a curved path visually similar to the surface of the chair along which the contact wheel 251 is moved, as shown in FIG. 23.

While various embodiments have been described above as being used to perform particular tasks and/or otherwise being used a particular ways, it should be understood that such uses have been presented by way of example only, and not limitation. Where methods and/or events described herein indicate certain events and/or procedures occurring in certain order, the ordering of certain events and/or procedures may be modified. Additionally, certain events and/or procedures may be performed concurrently in a parallel process when possible, as well as performed sequentially as described above.

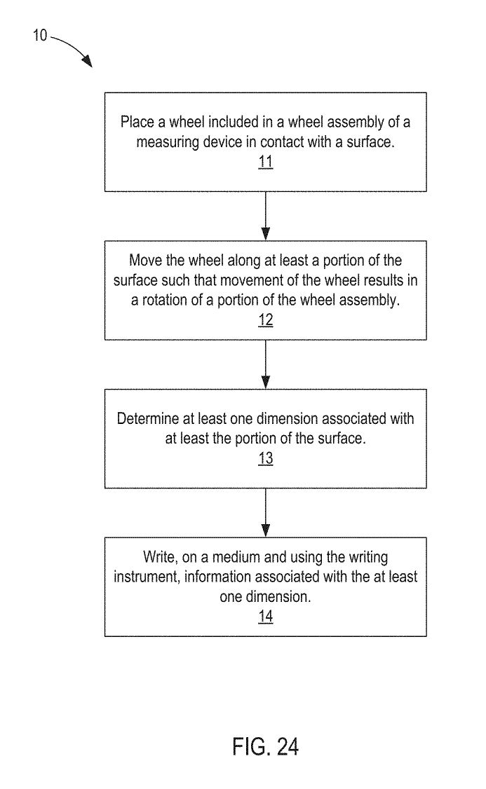

FIG. 24 is a flowchart illustrating an example method 10 of using a measuring device according to an embodiment. The measuring device can be any suitable device described herein. For example, in some embodiments, the measuring device can be similar to and/or the same as the measuring device 200 described above with reference to FIGS. 2-23. As such, the measuring device can include a first portion (e.g., similar to or substantially the same as the first portion 210) and a second portion (e.g., similar to or substantially the same as the second portion 270), removably coupled to the first portion. The first portion can include, for example, an electronics assembly (e.g., similar to or substantially the same as the electronics assembly 220) and a wheel assembly (e.g., similar to or substantially the same as the wheel assembly 250). The second portion can include a writing instrument (e.g., similar to or substantially the same as the writing instrument 290) and/or other device, member, instrument, etc. such as those described herein.

As shown in FIG. 24, the method 10 includes placing a wheel included in the wheel assembly in contact with a surface, at 11. The surface can be a surface or portion of a surface along which one or more measurements and/or dimensions is sought to be determined. The surface can be any suitable surface (or portion thereof) as described herein. The wheel is moved along at least a portion of the surface such that movement of the wheel results in a rotation of a portion of the wheel assembly, at 12. For example, in some embodiments, the rotation of the wheel results in a rotation of a magnetic member or the like included in the wheel assembly. In such embodiments, the magnetic member can have, can produce, and/or can otherwise be associated with a magnetic field such that rotation of the magnetic member results in a change in the magnetic field, as described in detail above with reference to the measuring device 200.

At least one dimension associated with at least the portion of the surface is determined, at 13. In some embodiments, for example, the electronics assembly included in the first portion of the measuring device can be configured to determine the at least one dimension based at least in part on rotation of the wheel along the surface (or portion thereof). In some embodiments, the electronics assembly can be configured to determine the at least one dimension based at least in part on one or more changes in the magnetic field associated with the magnetic member as a result of the magnetic member being rotated as the wheel is rotated, as in described above with reference to the measuring device 200.

Information associated with the at least one dimension is written on a medium using the writing instrument, at 14. For example, in some embodiments, the writing instrument can be a pencil or pencil lead, a pen or the like configured to release ink, chalk, and/or any other suitable device configured to produce a mark on the medium (e.g., paper or other article commonly used for writing or printing, wood, cardboard, drywall, plaster, glass, cloth, a portion of the user's body such as the user's hand, the surface being measured, and/or any other suitable surface). In other embodiments, the writing instrument can be a stylus or the like configured to provide an input to an external electronic device when placed in contact with a touch-sensitive display of the external electronic device (e.g., the touch-sensitive display can be the medium on which the information is written using the writing instrument (stylus)). As such, the user can manipulate the measuring device to write information associated with the at least one dimension on the medium.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals (e.g., propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, FORTRAN, etc.), functional programming languages (Haskell, Erlang, etc.), logical programming languages (e.g., Prolog), object-oriented programming languages (e.g., Java, C++, etc.), or other programming languages and/or other development tools. Additional examples of computer code include, but are not limited to, control signals, encrypted code, and compressed code.

What is claimed is:

1. An apparatus, comprising:
a first portion including a first housing, an electronics assembly disposed within the first housing, and a wheel assembly rotatably coupled to a first end portion of the first housing, the wheel assembly including a wheel configured to rotate in response to being moved along a surface and a magnetic member operably coupled to the wheel and configured to change a magnetic field in response to the rotation of the wheel, the electronics assembly configured to determine a measurement associated with the surface based on the change in the magnetic field; and
a second portion including a second housing, a first end portion of the second housing configured to removably couple to a second end portion of the first housing opposite the first end portion of the first housing, a second end portion of the second housing configured to at least partially house at least one of a writing instrument or an output instrument.

2. The apparatus of claim 1, wherein the electronics assembly includes an optical output device configured to project an output on the surface to provide a guide to a user as the user moves the wheel along a path on the surface.

3. The apparatus of claim 1, wherein the wheel is coupled to a first gear configured to rotate with the wheel as the wheel is moved along the surface, and
the magnetic member is coupled to a second gear, the second gear is in contact with the first gear such that rotation of the wheel results in a rotation of the second gear and the magnetic member, the rotation of the magnetic member operable to change the magnetic field.

4. The apparatus of claim 1, wherein the electronics assembly includes at least one sensor configured to sense a change in the magnetic field.

5. The apparatus of claim 1, wherein the second portion at least partially houses the writing instrument, the writing instrument being configured to produce an output on a medium.

6. The apparatus of claim 1, wherein the second portion at least partially houses the output instrument, the output instrument being configured to provide an input to an external electronic device when a portion of the output instrument is placed in contact with a touch-sensitive display of the external electronic device.

7. The apparatus of claim 1, wherein the wheel is configured to rotate in a first rotational direction when the wheel is moved in a first direction along the surface and is configured to rotate in a second rotational direction opposite the first rotational direction when the wheel is moved in a second direction along the surface opposite the first direction along the surface.

8. The apparatus of claim 7, wherein movement of the wheel along the surface in the first direction operable to increase the measurement as the wheel is rotated in the first direction, and movement of the wheel along the surface in the second direction is operable to decrease the measurement as the wheel is rotated in the second direction.

9. An apparatus, comprising:
a first housing having a first end portion and a second end portion and defining a cavity;
a wheel assembly coupled to the first end portion of the first housing, the wheel assembly including a wheel configured to rotate relative to the housing in response to being moved along a surface;
an electronics assembly disposed within the cavity, the electronics assembly including an optical output device configured to project an output on the surface to provide a guide to a user as the user moves the wheel along a path on the surface, the electronics assembly configured to determine a measurement associated with the path on the surface based on data associated with the rotation of the wheel relative to the housing;
a second housing having a first end portion and a second end portion, the first end portion of the second housing configured to removably couple to the second end portion of the first housing; and
a writing instrument coupled to the second end portion of the second housing and at least partially disposed therein.

10. The apparatus of claim 9, wherein the output of the optical output device is a beam of light, the optical output device is configured to project the beam of light on the surface to provide the guide to the user as the user moves the wheel along the path of the surface.

11. The apparatus of claim 9, wherein the optical output device is configured to provide an indicator to the user, the indicator is associated with at least one of the measurement or a status of at least a portion of the electronics assembly.

12. The apparatus of claim 9, wherein the wheel is coupled to a first gear configured to rotate with the wheel as the wheel is moved along the surface, and
the wheel assembly includes a second gear, the second gear is in contact with the first gear such that rotation of the wheel results in rotation of the second gear, the electronics assembly configured to determine the measurement based at least in part on rotation of the second gear.

13. The apparatus of claim 12, wherein the electronics assembly includes a magnetic member coupled to the second gear such that rotation of the second gear results in rotation of the magnetic member, the rotation of the magnetic member is operable to change a magnetic field associated with the magnetic member.

14. The apparatus of claim 13, wherein the electronics assembly is configured to determine the measurement based at least in part on the change in the magnetic field associated with the magnetic member.

15. The apparatus of claim 9, wherein the electronics assembly includes a battery pack having a having a positive terminal that is configured to be in electrical communication with a first electrical contact of the electronic assembly and a negative terminal that is configured to be in electrical communication with a second electrical contact of the electronic assembly, each of the positive terminal and the negative terminal being included in a first end portion of the battery pack.

16. The apparatus of claim 9, wherein the writing instrument is configured to produce an output on a medium.

17. A method of using a measuring device having a wheel assembly included in a first portion of the measuring device, an electronics assembly disposed within the first portion of the measuring device, and a writing instrument included in a second portion of the measuring device, the method comprising:
placing a wheel of the wheel assembly in contact with a surface;
moving the wheel along at least a portion of the surface, the movement of the wheel resulting in a rotation of a portion of the wheel assembly;
determining at least one dimension associated with at least the portion of the surface; and
writing, on a medium and using the writing instrument, information associated with the at least one dimension.

18. The method of claim 17, wherein the second portion of the measuring device is removably coupled to the first portion of the measuring device.

19. The method of claim 17, wherein moving the wheel along at least the portion of the surface results in rotation of a magnetic member included in the portion of the wheel assembly, the rotation of the magnetic member operable to change a magnetic field associated with the magnetic member.

20. The method of claim 19, wherein determining at least one dimension associated with at least the portion of the surface is based at least in part on the change in the magnetic field associated with the magnetic member.
